(19) United States
(12) Patent Application Publication
(10) Pub. No.: US 2026/0361441 A1
(43) Pub. Date: Nov. 12, 2026

(54) RECONFIGURABLE OPTICAL ADD-DROP MULTIPLEXER NODE

(71) Applicant: Huawei Technologies Co., Ltd., Shenzhen (CN)

(72) Inventors: Hamid Mehrvar, Ottawa (CA); Ruishan Chen, Dongguan (CN); Shiqiang Li, Shenzhen (CN); Wei Jia, Dongguan (CN); Ning Deng, Kowloon (HK); Liangjia Zong, Ottawa (CA)

(21) Appl. No.: 19/549,919

(22) Filed: Feb. 25, 2026

Related U.S. Application Data
(63) Continuation of application No. PCT/CN2023/127906, filed on Oct. 30, 2023.

(51) Int. Cl. H04J 14/02

(52) U.S. Cl. CPC H04J 14/0212

(57) ABSTRACT

A ROADM node includes D splitters, D sets of first wavelength select switches (WSSs), D sets of second WSSs, and D combiners. A set of first WSSs includes N first WSSs, and a set of second WSSs includes N second WSSs. A common port of the splitter is coupled to a first fiber, and N tributary ports of the splitter are coupled to common ports of the N first WSSs in the set of first WSSs respectively. At least part of K tributary ports of the first WSS are coupled to multiple second WSSs respectively, and at least part of K tributary ports of the second WSS are coupled to multiple first WSSs respectively. A common port of the combiner is coupled to a second fiber, and N tributary ports of the combiner are coupled to common ports of the N second WSSs in the set of second WSSs respectively.

### CROSS-REFERENCE TO RELATED APPLICATION

The present application is a continuation of PCT patent application No. PCT/CN2023/127906, filed on Oct. 30, 2023, application of which is hereby incorporated by reference in its entirety.

### TECHNICAL FIELD

The present disclosure relates to the field of optical communications, and in particular, to a reconfigurable optical add-drop multiplexer (ROADM) node.

### BACKGROUND

At present, in optical networks, ROADM nodes are used to perform various functions on light beams of different wavelengths. For example, the ROADM node adds, drops, and redirects light beams of specific wavelengths.

In general, the degree of the ROADM node is defined as the total number of fiber pairs (including an input fiber and an output fiber) connected to the ROADM node. Given a limited capacity of a single fiber, as traffic increases, network operators add multiple fibers to their networks. With the deployment of new fibers, the degree of the ROADM node needs to be increased accordingly.

### SUMMARY

Embodiments of the present disclosure provide a ROADM node to solve the problem of degree scaling.

To achieve the above objective, the following technical solutions are adopted in the present disclosure.

A ROADM node includes D splitters, D sets of first wavelength select switches (WSSs), D sets of second WSSs, and D combiners. A splitter has one common port and N tributary ports. A set of first WSSs includes N first WSSs, and a first WSS of the N first WSSs has one common port and K tributary ports. A set of second WSSs includes N second WSSs, and a second WSS of the N second WSSs has one common port and K tributary ports. A combiner has one common port and N tributary ports. The common port of the splitter is used for being coupled to a first fiber, and the N tributary ports of the splitter are coupled to common ports of the N first WSSs in the set of first WSSs respectively. At least part of the K tributary ports of the first WSS are coupled to tributary ports of multiple second WSSs in the D sets of second WSSs respectively, and at least part of the K tributary ports of the second WSS are coupled to tributary ports of multiple first WSSs in the D sets of first WSSs respectively. The common port of the combiner is used for being coupled to a second fiber, and the N tributary ports of the combiner are coupled to common ports of the N second WSSs in the set of second WSSs respectively. K is greater than a quotient obtained by dividing D by N (K>D/N), N is greater than or equal to 2 (N≥2), and D, N, K, D/N are all positive integers.

In the above ROADM node, the splitters at a first stage, the first WSSs at a second stage, the second WSSs at a third stage, and the combiners at a fourth stage together constitute a four-stage architecture. A first fiber in a degree (direction) is coupled to N first WSSs in a set of first WSSs through a splitter, the N first WSSs in the set of first WSSs are coupled to second WSSs located in different sets of second WSSs in D sets of second WSSs, and N second WSSs in a set of second WSSs are coupled to a second fiber in the degree through a combiner. As such, according to different types of splitters and combiners, as well as WSSs of different sizes, by combining the splitter, the combiner and the WSSs, it may be possible to flexibly couple a first fiber in a degree to second fibers in multiple degrees. Since N first WSSs are coupled to the splitter, and N second WSSs are coupled to the combiner, compared to the solution of coupling only one WSS in a degree, this solution may achieve multiple degrees and has the capability to scale to higher degrees.

In some embodiments, the set of first WSSs is fully connected to the D sets of second WSSs. In this way, during transmission of signals from first fibers to second fibers, wavelengths received by a first fiber in any degree may be assigned to a second fiber in any degree, thereby achieving mesh connectivity and enabling the ROADM node to have colorless and directionless abilities.

In some embodiments, the D sets of second WSSs include N clusters each including D/N sets of second WSSs. D/N tributary ports of each first WSS in the set of first WSSs are coupled to tributary ports of D/N second WSSs in a j-th cluster corresponding to each first WSS in a one-to-one correspondence, and any two of the D/N second WSSs in the j-th cluster are located in different sets of second WSSs; j is a positive integer greater than or equal to 1 and less than or equal to N (1≤j≤N). Since the D/N tributary ports of each first WSS in the set of first WSSs are coupled to tributary ports of D/N second WSSs in a corresponding cluster in a one-to-one correspondence, and the D/N second WSSs in the cluster are located in D/N sets of second WSSs respectively, it may be possible to connect the set of first WSSs to a second WSS in each direction, thereby achieving full connection.

In some embodiments, the set of second WSSs is fully connected to the D sets of first WSSs. In this way, during transmission of signals from first fibers to second fibers, a second fiber in any degree can receive wavelengths transmitted by first fibers in all degrees, thereby achieving mesh connectivity and enabling the ROADM node to have colorless and directionless abilities.

In some embodiments, the D sets of first WSSs include N clusters each including D/N sets of first WSSs. D/N tributary ports of each second WSS in the set of second WSSs are coupled to tributary ports of D/N first WSSs in an i-th cluster corresponding to each second WSS in a one-to-one correspondence, and any two of the D/N first WSSs in the i-th cluster are located in different sets of first WSSs; i is a positive integer greater than or equal to 1 and less than or equal to N (1≤i≤N). Since the D/N tributary ports of each second WSS in the set of second WSSs are coupled to tributary ports of D/N first WSSs in a corresponding cluster in a one-to-one correspondence, and the D/N first WSSs in the cluster are located in D/N sets of first WSSs respectively, it may be possible to connect the set of second WSSs to a first WSS in each direction, thereby achieving full connection.

In some embodiments, K is greater than or equal to 16 (K≥16). In this way, it may be possible to obtain higher degrees using less splitters, combiners and WSSs.

In some embodiments, D=N×(K×S′), where K represents the number of tributary ports of the first WSS that is coupled to second WSSs; S′ represents the number of tributary ports of the first WSS different from tributary ports coupled to second WSSs, and S′ is a positive integer less than K (S′<K). The tributary ports of the first WSS different from the tributary ports coupled to the second WSSs include tributary ports for add/drop and other tributary ports except the tributary ports for add/drop and the tributary ports coupled to the second WSSs. For example, D is equal to 60 (D=60), N is equal to 2 (N=2), and K is equal to 32 (K=32); or D is equal to 120 (D=120), N is equal to 2 (N=2), and K is equal to 64 (K=64); or D is equal to 120 (D=120), N is equal to 4 (N=4), and K is equal to 32 (K=32). Through these combinations, it may be possible to achieve optical configuration of the node.

In some embodiments, the splitter is a WSS. In this way, the WSS may be used as the splitter.

In some embodiments, the combiner is a WSS. In this way, the WSS may be used as the combiner.

In some embodiments, the ROADM node includes a plurality of line card chassis, and each of the line card chassis includes a plurality of line cards. A line card includes a first WSS in the D sets of first WSSs and/or a second WSS in the D sets of second WSSs. In this way, a conventional chassis may be used to house the components in the ROADM node.

In some embodiments, the line card includes one first WSS, one second WSS and one of the D splitters; or the line card includes one first WSS, one second WSS and one of the D combiners; or the line card includes two first WSSs, two second WSSs, one of the D splitters and one of the D combiners; or the line card includes two first WSSs and one of the D splitters; or the line card includes two second WSSs and one of the D combiners. This allows for flexible design of line cards in the line card chassis.

In some embodiments, the ROADM node further includes at least one add-drop component coupled to S tributary ports of the first WSS; S is less than K (S<K), and S is a positive integer. In the first WSS, the S tributary ports coupled to the at least one add-drop component are different from tributary ports coupled to second WSSs. By adding the add-drop component, the ROADM node may be able to drop/add wavelengths flexibly.

In some embodiments, the ROADM node further includes at least one add-drop component coupled to T tributary ports of the second WSS; T is less than K (T<K), and T is a positive integer. In the second WSS, the T tributary ports coupled to the at least one add-drop component are different from tributary ports coupled to first WSSs. By adding the add-drop component, the ROADM node may be able to add/drop wavelengths flexibly.

In some embodiments, an add-drop component in the at least one add-drop component includes D′ third WSSs and K add-drop cards, and a third WSS of the D′ third WSSs has one common port and K tributary ports; D′ is a positive integer. Common ports of the D′ third WSSs are coupled to D′ tributary ports of first WSSs or second WSSs in a one-to-one correspondence, and the K tributary ports of the third WSS are coupled to the K add-drop cards respectively. Through such arrangement, the first WSSs or second WSSs coupled to the D′ third WSSs can simultaneously perform dropping or adding wavelengths.

In some embodiments, D′ is equal to D (D′=D); the common ports of the D third WSSs in the add-drop component are coupled to the D tributary ports of D first WSSs or D second WSSs. Through such arrangement, the configuration of the node may be further optimized as all wavelengths can be dropped from D first fibers or added to D second fibers.

In some embodiments, for the at least one add-drop component coupled to the S tributary ports of the first WSS, the at least one add-drop component includes M add-drop components, M being a positive integer greater than or equal to 2 and less than or equal to N×S (2≤M≤N×S); and the D first WSSs coupled to the D third WSSs in the add-drop component are located in the D sets of first WSSs respectively, and first WSSs in each set of first WSSs are coupled to different add-drop components. For the at least one add-drop component coupled to the T tributary ports of the second WSS, the at least one add-drop component includes M′ add-drop components, M′ being a positive integer greater than or equal to 2 and less than or equal to N×T (2≤M′≤N×T); and the D second WSSs coupled to the D third WSSs in the add-drop component are located in the D sets of second WSSs respectively, and second WSSs in each set of second WSSs are coupled to different add-drop components. In this way, each add-drop component may be able to add/drop wavelengths in all degrees.

In some embodiments, an add-drop card of the K add-drop cards includes an add-drop module with Q input ports and P output ports, and a plurality of fourth WSSs each having one common port and U tributary ports; the common port of each fourth WSS is coupled to one of the Q input ports of the add-drop module, and the U tributary ports of the fourth WSS are coupled to U third WSSs of the D′ third WSSs in the add-drop component respectively; U is less than D′ (U<D′), and U, P and Q are all positive integers. The P output ports of the add-drop module are used for dropping or adding wavelengths. By combining the add-drop module and the plurality of fourth WSSs to obtain the add-drop card, it may be possible to make the add-drop component colorless, directionless and contentionless.

In some embodiments, an add-drop card in the K add-drop cards includes an add-drop module with Q′ input ports and P output ports, and at least part of the Q′ input ports of the add-drop module are coupled to the D′ third WSSs in the add-drop component in a one-to-one correspondence; Q′ is greater than or equal to D′ (Q′≥D′), and P and Q′ are both positive integers. The P output ports of the add-drop module are used for dropping or adding wavelengths. In this way, a colorless and directionless add-drop component may be adopted.

In some embodiments, the ROADM node includes at least one WSS chassis and at least one add-drop card chassis corresponding to each add-drop component. The D′ third WSSs in the add-drop component are installed in the at least one WSS chassis, and the K add-drop cards in the add-drop component are installed in the at least one add-drop card chassis. By using different chassis to place the third WSSs and the add-drop cards in the add-drop component separately, the connection between the third WSSs and the add-drop cards may be facilitated.

In some embodiments, the ROADM node includes at least one add-drop card chassis corresponding to each add-drop component, and an add-drop card chassis includes a mid-plane and slots located on both sides of the mid-plane. At least part of the D′ third WSSs in the add-drop component are installed in slots located on a side of the mid-plane, and at least part of the K add-drop cards in the add-drop component are installed in slots located on another side of the mid-plane. By using a large chassis to place the third WSSs and the add-drop cards in the add-drop component, the number of chassis used may be reduced.

### BRIEF DESCRIPTION OF THE DRAWINGS

FIG. 1 is a schematic diagram of a chassis of a 16-degree ROADM node provided in embodiments of the present disclosure;

FIG. 2 is a diagram showing connections of WSSs in a line card in the ROADM node shown in FIG. 1;

FIG. 3 is a schematic diagram of lines part of a ROADM node provided in embodiments of the present disclosure;

FIG. 4 is a schematic diagram of lines part of another ROADM node provided in embodiments of the present disclosure;

FIG. 5 is a schematic diagram of lines part of yet another ROADM node provided in embodiments of the present disclosure;

FIG. 6 is a schematic diagram of lines part of yet another ROADM node provided in embodiments of the present disclosure;

FIG. 7 is a schematic diagram of lines part of yet another ROADM node provided in embodiments of the present disclosure;

FIGS. 8A-8D are schematic diagrams of lines part of yet another ROADM node provided in embodiments of the present disclosure;

FIG. 9 is a schematic diagram of a chassis corresponding to lines part provided in embodiments of the present disclosure;

FIG. 10 is a schematic diagram of another chassis corresponding to lines part provided in embodiments of the present disclosure;

FIG. 11 is a schematic diagram of an add-drop component provided in embodiments of the present disclosure;

FIG. 12 is a schematic diagram of another add-drop component provided in embodiments of the present disclosure;

FIG. 13 is a schematic diagram of a chassis corresponding to an add-drop component provided in embodiments of the present disclosure;

FIG. 14 is a schematic diagram of a chassis corresponding to another add-drop component provided in embodiments of the present disclosure;

FIG. 15 is a schematic diagram of another chassis corresponding to an add-drop component provided in embodiments of the present disclosure; and

FIG. 16 is a schematic diagram of another chassis corresponding to another add-drop component provided in embodiments of the present disclosure.

### DETAILED DESCRIPTION

Technical solutions in embodiments of the present disclosure will be described clearly and completely with reference to the accompanying drawings below. Obviously, the described embodiments are merely some but not all embodiments of the present disclosure. All other embodiments obtained by a person of ordinary skill in the art based on the embodiments of the present disclosure shall be included in the protection scope of the present disclosure.

Unless the context requires otherwise, throughout the description and the claims, the term “comprise” and other forms thereof such as the third-person singular form “comprises” and the present participle form “comprising” are construed as open and inclusive meanings, i.e., “including, but not limited to”. In the description, the terms such as “one embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or examples(s). In addition, the specific features, structures, materials or characteristics may be included in any one or more embodiments or examples in any suitable manner.

Hereinafter, the terms “first” and “second” are used for descriptive purposes only, and are not to be construed as indicating or implying the relative importance or implicitly indicating the number of indicated technical features. Thus, a feature defined with “first” or “second” may explicitly or implicitly include one or more of the features. In the description of the embodiments of the present disclosure, the terms “a/the plurality of” and “multiple” means two or more unless otherwise specified.

Orientation terms such as “upper”, “lower”, “left”, “right”, “horizontal” and “vertical” are defined relative to the indicated position of the components in the drawings. It will be understood that these orientation terms are relative concepts that can be used for relative description and clarification, and they can change accordingly if the orientation of the components changes in the drawings.

In the description of some embodiments, the terms “coupled” and “connected” and derivatives thereof may be used. For example, the term “connected” may be used in the description of some embodiments to indicate that two or more components are in direct physical or electrical contact with each other. For another example, the term “coupled” may be used in the description of some embodiments to indicate that two or more components are in direct physical or electrical contact. However, the term “coupled” may also mean that two or more components are not in direct contact with each other, but still cooperate or interact with each other. The embodiments disclosed herein are not necessarily limited to the content herein.

The phrase “A and/or B” includes the following three combinations: only A, only B, and a combination of A and B.

ROADMs are used in systems that employ wavelength division multiplexing allowing data traffic modulated on a wavelength to be added at a source node and then passed through one or more ROADM nodes before the data traffic is dropped at a destination node. Once dropped, the destination node demodulates the light and decodes the data into electronic bits.

The ROADM node plays a key role in switching and transporting of high volume of data. The ROADM node is characterized by two parameters, one is the number of directions (i.e., the number of degrees), and the other is the number of wavelengths that can be added or dropped.

At present, due to a size of a key component (i.e., wavelength select switch (WSS)) in the design of the ROADM node, the degree (i.e., the number of directions) that the ROADM node may offer is 8 or 16.

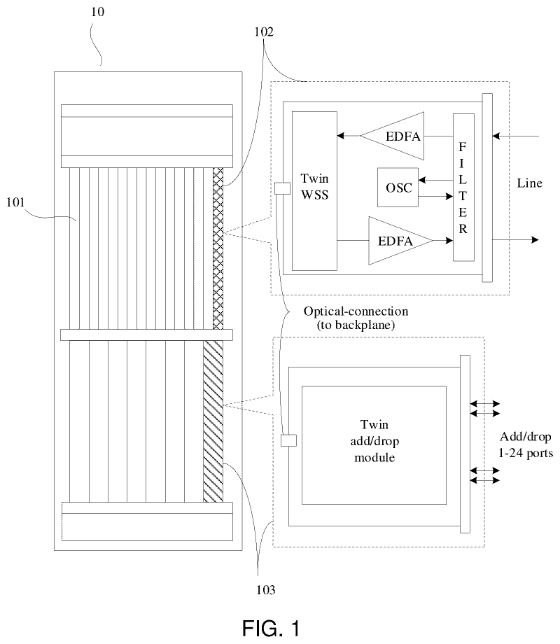

In an example where the degree of the ROADM node is 16, as shown in FIG. 1, a chassis 10 may include 32 slots 101 for inserting multiple line cards 102 and multiple add-drop cards 103. Each slot 101 may be interconnected to other slots 101 through an optical backplane. The line card 102 performs line function as it may be interconnected to other ROADM nodes. Each line card 102 may be connected to one fiber pair, and may occupy a single slot of the chassis 10. The add-drop card 103 processes dropped wavelengths or added wavelengths, and may occupy two slots 101.

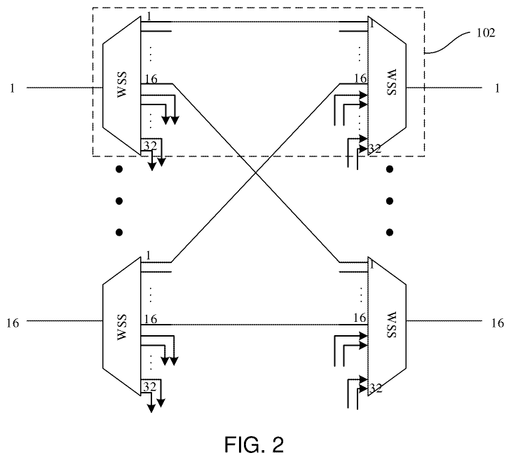

The line card 102 may include two WSSs, where connections of WSSs in 16 line cards 102 are shown in FIG. 2. In addition, the line card 102 may further include a filter, two erbium doped fiber amplifiers (EDFAs) and a circuitry for optical service channel (OSC). The add-drop card 103 may include one add-module and one drop-module, and each module may include 24 add/drop ports allowing for up to 24 wavelengths to be added to or dropped at the ROADM node.

With increased traffic (i.e., increased demand for network capacity), there is a need for a ROADM with higher number of degrees to allow transmission in many different directions and a corresponding flexibility.

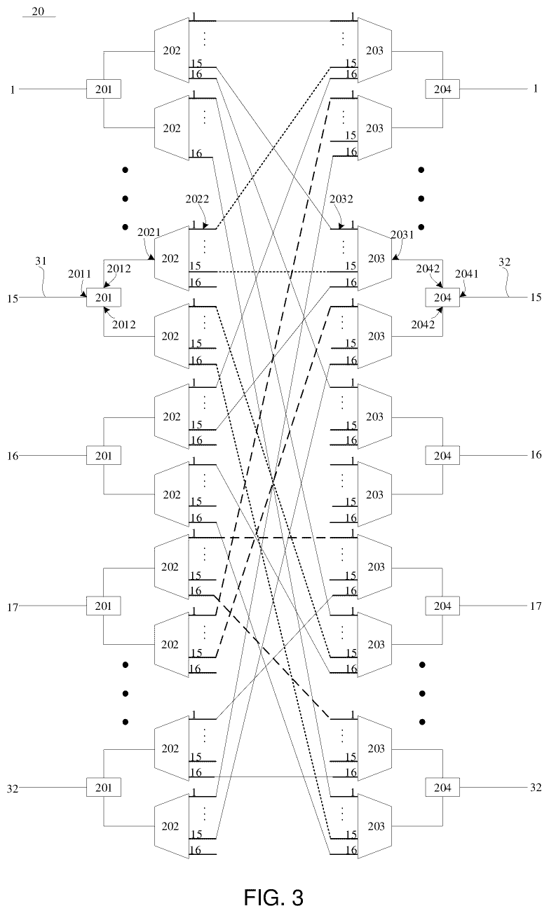

Based on this, embodiments of the present disclosure provide a ROADM node. As shown in FIGS. 3 to 8D, the ROADM node 20 includes D splitters 201, D sets of first wavelength select switches (WSSs) 202, D sets of second WSSs 203, and D combiners 204. A splitter 201 has one common port 2011 and N tributary ports 2012. A set of first WSSs 202 includes N first WSSs 202, and a first WSS 202 of the N first WSSs 202 has one common port 2021 and K tributary ports 2022. A set of second WSSs 203 includes N second WSSs 203, and a second WSS 203 of the N second WSSs 203 has one common port 2031 and K tributary ports 2032. A combiner 204 has one common port 2041 and N tributary ports 2042. K is greater than a quotient obtained by dividing D by N (K>D/N), N is greater than or equal to 2 (N≥2), and D, N, K, D/N are all positive integers.

The common port 2011 of the splitter 201 is used for being coupled to a first fiber 31, and the N tributary ports 2012 of the splitter 201 are coupled to common ports 2021 of the N first WSSs 202 in the set of first WSSs 202 respectively.

The common port 2041 of the combiner 204 is used for being coupled to a second fiber 32, and the N tributary ports 2042 of the combiner 204 are coupled to common ports 2031 of the N second WSSs 203 in the set of second WSSs 203 respectively.

At least part of the K tributary ports 2022 of the first WSS 202 are coupled to tributary ports 2032 of multiple second WSSs 203 in the D sets of second WSSs 203 respectively, and at least part of the K tributary ports 2032 of the second WSS 203 are coupled to tributary ports 2022 of multiple first WSSs 202 in the D sets of first WSSs 202 respectively.

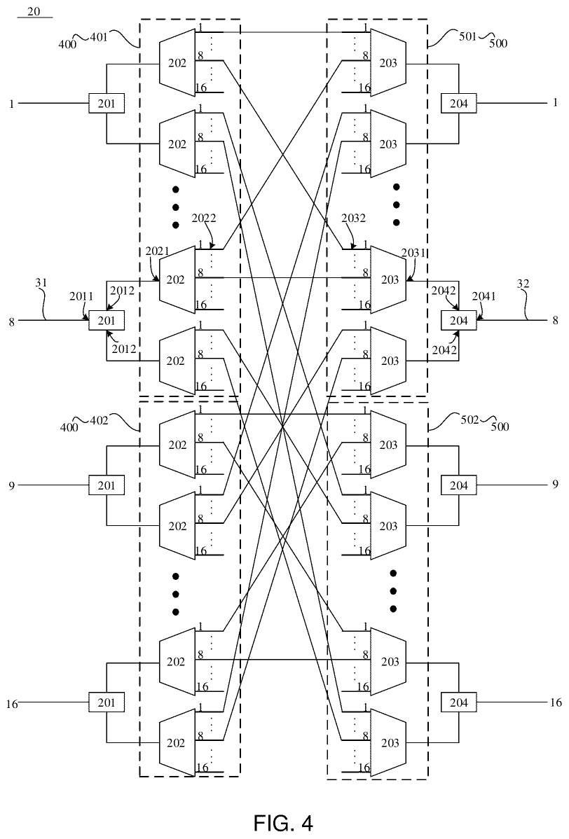

It will be understood that, for the at least part of the K tributary ports 2022 of the first WSS 202, each tributary port 2022 is coupled to a tributary port 2032 of a second WSS 203; and for the at least part of the K tributary ports 2032 of the second WSS 203, each tributary port 2032 is coupled to a tributary port 2022 of a first WSS 202. In addition, FIG. 3 shows a scenario in which a set of first WSSs 202 in a direction (degree) may be coupled to second WSSs 203 in all directions, or may be coupled to second WSSs 203 in some directions (that is, FIG. 3 provides partial connectivity), whereas FIGS. 4 to 8D provide full connectivity.

Referring to FIG. 3, with the two first WSSs 202 in the first direction (degree) as an example, the first tributary port 2022 of the upper first WSS 202 may be coupled to the first tributary port 2032 of the upper second WSS 203 in the first direction; the second tributary port 2022 of the upper first WSS 202 may be coupled to the first tributary port 2032 of the upper second WSS 203 in the second direction; the third tributary port 2022 of the upper first WSS 202 may be coupled to the first tributary port 2032 of the upper second WSS 203 in the third direction; the fourth tributary port 2022 of the upper first WSS 202 may be coupled to the first tributary port 2032 of the upper second WSS 203 in the fourth direction; and so forth . . . ; the 16th tributary port 2022 of the upper first WSS 202 may be coupled to the first tributary port 2032 of the upper second WSS 203 in the 16th direction. The first tributary port 2022 of the lower first WSS 202 may be coupled to the first tributary port 2032 of the lower second WSS 203 in the 17th direction; the second tributary port 2022 of the lower first WSS 202 may be coupled to the first tributary port 2032 of the lower second WSS 203 in the 18th direction; the third tributary port 2022 of the lower first WSS 202 may be coupled to the first tributary port 2032 of the lower second WSS 203 in the 19th direction; the fourth tributary port 2022 of the lower first WSS 202 may be coupled to the first tributary port 2032 of the lower second WSS 203 in the 20th direction; and so forth . . . ; the 16th tributary port 2022 of the lower first WSS 202 may be coupled to the first tributary port 2032 of the lower second WSS 203 in the 32nd direction.

Referring to FIG. 3, With the two first WSSs 202 in the 15th direction (degree) as an example, the first tributary port 2022 of the upper first WSS 202 may be coupled to the 15th tributary port 2032 of the upper second WSS 203 in the first direction; the second tributary port 2022 of the upper first WSS 202 may be coupled to the 15th tributary port 2032 of the upper second WSS 203 in the second direction; the third tributary port 2022 of the upper first WSS 202 may be coupled to the 15th tributary port 2032 of the upper second WSS 203 in the third direction; the fourth tributary port 2022 of the upper first WSS 202 may be coupled to the 15th tributary port 2032 of the upper second WSS 203 in the fourth direction; and so forth . . . ; the 15th tributary port 2022 of the upper first WSS 202 may be coupled to the 15th tributary port 2032 of the upper second WSS 203 in the 15th direction. It will be noted that the 16th tributary port 2022 of the upper first WSS 202 may not be coupled to the second WSS 203. The first tributary port 2022 of the lower first WSS 202 may be coupled to the 15th tributary port 2032 of the lower second WSS 203 in the 17th direction; the second tributary port 2022 of the lower first WSS 202 may be coupled to the 15th tributary port 2032 of the lower second WSS 203 in the 18th direction; the third tributary port 2022 of the lower first WSS 202 may be coupled to the 15th tributary port 2032 of the lower second WSS 203 in the 19th direction; the fourth tributary port 2022 of the lower first WSS 202 may be coupled to the 15th tributary port 2032 of the lower second WSS 203 in the 20th direction; and so forth . . . ; the 16th tributary port 2022 of the lower first WSS 202 may be coupled to the 15th tributary port 2032 of the lower second WSS 203 in the 32nd direction.

Referring to FIG. 3, With the two first WSSs 202 in the 16th direction (degree) as an example, the first tributary port 2022 of the upper first WSS 202 may be coupled to the 16th tributary port 2032 of the upper second WSS 203 in the first direction; the third tributary port 2022 of the upper first WSS 202 may be coupled to the 16th tributary port 2032 of the upper second WSS 203 in the third direction; the fifth tributary port 2022 of the upper first WSS 202 may be coupled to the 16th tributary port 2032 of the upper second WSS 203 in the fifth direction; the seventh tributary port 2022 of the upper first WSS 202 may be coupled to the 16th tributary port 2032 of the upper second WSS 203 in the seventh direction; the ninth tributary port 2022 of the upper first WSS 202 may be coupled to the 16th tributary port 2032 of the upper second WSS 203 in the ninth direction; and so forth . . . ; the 15th tributary port 2022 of the upper first WSS 202 may be coupled to the 16th tributary port 2032 of the upper second WSS 203 in the 15th direction. It will be noted that the 2nd, 4th, 6th, 8th, 10th, 12th, 14th, and 16th tributary ports 2022 of the upper first WSS 202 may not be coupled to the second WSSs 203. The first tributary port 2022 of the lower first WSS 202 may be coupled to the 16th tributary port 2032 of the lower second WSS 203 in the 17th direction; the second tributary port 2022 of the lower first WSS 202 may be coupled to the 16th tributary port 2032 of the lower second WSS 203 in the 18th direction; the third tributary port 2022 of the lower first WSS 202 may be coupled to the 16th tributary port 2032 of the lower second WSS 203 in the 19th direction; the fourth tributary port 2022 of the lower first WSS 202 may be coupled to the 16th tributary port 2032 of the lower second WSS 203 in the 20th direction; and so forth . . . ; the 16th tributary port 2022 of the lower first WSS 202 may be coupled to the 16th tributary port 2032 of the lower second WSS 203 in the 32nd direction.

Referring to FIG. 3, With the two first WSSs 202 in the 17th direction (degree) as an example, the first tributary port 2022 of the upper first WSS 202 may be coupled to the first tributary port 2032 of the upper second WSS 203 in the 17th direction; the second tributary port 2022 of the upper first WSS 202 may be coupled to the first tributary port 2032 of the upper second WSS 203 in the 18th direction; the third tributary port 2022 of the upper first WSS 202 may be coupled to the first tributary port 2032 of the upper second WSS 203 in the 19th direction; the fourth tributary port 2022 of the upper first WSS 202 may be coupled to the first tributary port 2032 of the upper second WSS 203 in the 20th direction; and so forth . . . ; the 16th tributary port 2022 of the upper first WSS 202 may be coupled to the first tributary port 2032 of the upper second WSS 203 in the 32nd direction. The first tributary port 2022 of the lower first WSS 202 may be coupled to the first tributary port 2032 of the lower second WSS 203 in the first direction; the third tributary port 2022 of the lower first WSS 202 may be coupled to the first tributary port 2032 of the lower second WSS 203 in the third direction; the fifth tributary port 2022 of the lower first WSS 202 may be coupled to the first tributary port 2032 of the lower second WSS 203 in the fifth direction; the seventh tributary port 2022 of the lower first WSS 202 may be coupled to the first tributary port 2032 of the lower second WSS 203 in the seventh direction; the ninth tributary port 2022 of the lower first WSS 202 may be coupled to the first tributary port 2032 of the lower second WSS 203 in the ninth direction; and so forth . . . ; the 15th tributary port 2022 of the lower first WSS 202 may be coupled to the first tributary port 2032 of the lower second WSS 203 in the 15th direction. It will be noted that the 2nd, 4th, 6th, 8th, 10th, 12th, 14th, and 16th tributary ports 2022 of the lower first WSS 202 may not be coupled to the second WSSs 203.

For example, the D sets of first WSSs 202 and the D sets of second WSSs 203 may be coupled through an optical backplane.

In the embodiments of the present disclosure, the D splitters 201, D sets of first WSSs 202, D sets of second WSSs 203, and D combiners 204 together constitute a four-stage architecture. The D splitters 201 are at the first stage, the D sets of first WSSs 202 are at the second stage, the D sets of second WSSs 203 are at the third stage, and the D combiners 204 are at the fourth stage. The splitters at the first stage are 1×N splitters, the first WSSs at the second stage are 1×K WSSs, the second WSSs at the third stage are K×1 WSSs, and the combiners at the fourth stage are N×1 combiners. It can be seen that the four-stage architecture is a symmetrical architecture.

For example, the first fiber 31 is an input fiber, and the second fiber 32 is an output fiber; or, the second fiber 32 is an input fiber, and the first fiber 31 is an output fiber. For convenience of description, the following embodiments are described by taking an example where the first fiber 31 is an input fiber, and the second fiber 32 is an output fiber. The first fiber 31 and the second fiber 32 can be single-mode fibers (SMFs) or multi-core fibers (MCFs).

The N 1×K WSSs (i.e., a set of first WSSs 202) at the second stage that are coupled to the splitter at the first stage and the N K×1 WSSs (i.e., a set of second WSSs 203) at the third stage that are coupled to a corresponding combiner at the fourth stage form a direction of the multiple directions of the ROADM structure. For example, the ROADM node further includes a controller, and the controller manages the N first WSSs 202 of a direction, so as to ensure that same wavelengths will not be transmitted to the tributary port 2042 of the combiner 204.

Although there are N 1×K WSSs and N K×1 WSSs in each direction, there are only two WSSs in a light-path connection, with one 1×K WSS used for ingress (signal in) and one K×1 WSS used for egress (signal out).

The polarization dependent loss (PDL) associated with each of two perpendicular polarized light carrying signal information is considered to be lowest when the number of WSSs in the light-path connection is 2. For each WSS, this parameter on average is 0.4 dB.

It will be noted that, the splitter 201 is coupled to N 1×K WSSs, which means there are N×K tributary ports at the second stage in each direction (degree). Correspondingly, the combiner 204 is coupled to N K×1 WSSs, which means there are N×K tributary ports at the third stage in each direction (degree). As such, the value of D may be greater than or equal to the value of K.

Based on this four-stage architecture, the scaling of the degrees of the ROADM node is not limited to the size of the WSS. On this basis, in the embodiments of the present disclosure, a WSS of existing size may be used; or, the size of the WSS may be expanded.

For example, K≥16. For example, K=16, 32, or 64. With this arrangement, it may be possible to use less splitters, combiners and WSSs to achieve higher degrees.

For example, the WSS may adopt a liquid crystal on silicon (LCOS) technology.

For example, D≥16. For example, D=16, 30, 32, 60, or 120.

In the ROADM node provided in the embodiments of the present disclosure, the splitters at the first stage, the first WSSs at the second stage, the second WSSs at the third stage, and the combiners at the fourth stage together constitute the four-stage architecture. A first fiber in a degree (direction) is coupled to N first WSSs in a set of first WSSs through a splitter, the N first WSSs in the set of first WSSs are coupled to second WSSs located in different sets of second WSSs in D sets of second WSSs, and N second WSSs in a set of second WSSs are coupled to a second fiber in the degree through a combiner. As such, according to different types of splitters and combiners, as well as WSSs of different sizes, by combining the splitter, the combiner and the WSSs, it may be possible to flexibly couple a first fiber in a degree to second fibers in multiple degrees. Since N first WSSs are coupled to the splitter, and N second WSSs are coupled to the combiner, compared to the solution of coupling only one WSS in a degree, this solution may achieve multiple degrees and has the capability to scale to higher degrees. In addition, the ROADM node may support both flex-grid and fixed-grid with no loss of spectrum; therefore, it may support full spectrum switching from input to output. On this basis, the controller may manage the WSSs at the second stage to select wavelengths at their inputs, so that there are no two same wavelengths at the inputs of the WSSs at the third stage resulting in crosstalk for that wavelength. As a result, it may be possible to achieve a no-crosstalk and non-blocking architecture.

In some embodiments, as shown in FIGS. 4 to 8D, a set of first WSSs 202 are fully connected to D sets of second WSSs 203.

In this way, during the transmission of signals from first fibers 31 to second fibers 32, wavelengths received by a first fiber 31 in any degree may be assigned to a second fiber 32 in any degree, thereby achieving mesh connectivity and enabling the ROADM node to have colorless and directionless abilities.

In some implementations, as shown in FIGS. 4 to 8D, D sets of second WSSs 203 may be divided into N second clusters 500, and each second cluster 500 includes D/N sets of second WSSs 203. D/N tributary ports 2022 of each first WSS 202 in the set of first WSSs 202 are coupled to tributary ports 2032 of D/N second WSSs 203 in a j-th second cluster 500 corresponding to each first WSS 202 in a one-to-one correspondence, and any two of the D/N second WSSs 203 in the j-th cluster 500 are located in different sets of second WSSs 203, where j is a positive integer greater than or equal to 1 and less than or equal to N (1≤j≤N).

It will be understood that any set of second WSSs 203 located in a second cluster 500 is not located in another second cluster 500. With FIG. 4 as an example, any set of second WSSs 203 located in the second cluster 501 is not located in the second cluster 502, and any set of second WSSs 203 located in the second cluster 502 is not located in the second cluster 501.

N first WSSs 202 in a set of first WSSs 202 are coupled to N second clusters 500 respectively. Still with FIG. 4 as an example, two first WSSs 202 in a set of first WSSs 202 are coupled to two second clusters 500 respectively. The upper first WSS 202 in the set of first WSSs 202 may be coupled to the second cluster 501, and the lower first WSS 202 of the set of first WSSs 202 may be coupled to the second cluster 502; or, the upper first WSS 202 in the set of first WSSs 202 may be coupled to the second cluster 502, and the lower first WSS 202 of the set of first WSSs 202 may be coupled to the second cluster 501.

Since the D/N tributary ports 2022 of each first WSS 202 in the set of first WSSs 202 are coupled to tributary ports 2032 of D/N second WSSs 203 in a corresponding second cluster 500 in a one-to-one correspondence, and the D/N second WSSs 203 in the second cluster 500 are located in D/N sets of second WSSs 203 in the second cluster 500 respectively, it may be possible to connect the set of first WSSs 202 to a second WSS 203 in each direction, thereby realizing full connectivity.

In some embodiments, as shown in FIGS. 4 to 8D, a set of second WSSs 203 are fully connected to D sets of first WSSs 202.

In this way, during the transmission of signals from the first fibers 31 to the second fibers 32, a second fiber 32 in any degree can receive wavelengths transmitted by the first fibers 31 in all degrees, thereby achieving mesh connectivity and enabling the ROADM node to have colorless and directionless abilities.

In some implementations, as shown in FIGS. 4 to 8D, D sets of first WSSs 202 may be divided into N first clusters 400, and each first cluster 400 includes D/N sets of first WSSs 202. D/N tributary ports 2032 of each second WSS 203 in the set of second WSSs 203 are coupled to tributary ports 2022 of D/N first WSSs 202 in an i-th first cluster 400 corresponding to each second WSS 203 in a one-to-one correspondence, and any two of the D/N first WSSs 202 in the i-th cluster 400 are located in different sets of first WSSs 202, where i is a positive integer greater than or equal to 1 and less than or equal to N (1≤i≤N).

It will be understood that any set of first WSSs 202 located in a first cluster 400 is not located in another first cluster 400. With FIG. 4 as an example, any set of first WSSs 202 located in the first cluster 401 is not located in the first cluster 402, and any set of first WSSs 202 located in the first cluster 402 is not located in the first cluster 401.

N second WSSs 203 in a set of second WSSs 203 are coupled to N first clusters 400 respectively. Still with FIG. 4 as an example, two second WSSs 203 in a set of second WSSs 203 are coupled to two first clusters 400 respectively. The upper second WSS 203 in the set of second WSSs 203 may be coupled to the first cluster 401, and the lower second WSS 203 of the set of second WSSs 203 may be coupled to the first cluster 402; or, the upper second WSS 203 in the set of second WSSs 203 may be coupled to the first cluster 402, and the lower second WSS 203 of the set of second WSSs 203 may be coupled to the first cluster 401.

Since the D/N tributary ports 2032 of each second WSS 203 in the set of second WSSs 203 are coupled to tributary ports 2022 of D/N first WSSs 202 in a corresponding first cluster 400 in a one-to-one correspondence, and the D/N first WSSs 202 in the first cluster 400 are located in D/N sets of first WSSs 202 in the first cluster 400 respectively, it may be possible to connect the set of second WSSs 203 to a first WSS 202 in each direction, thereby realizing full connectivity.

In some examples, D=N×(K−S′), where K represents the number of tributary ports 2022 of the first WSS 202 that is coupled to second WSSs 203, S′ represents the number of tributary ports 2022 of the first WSS 202 different from tributary ports 2022 coupled to the second WSSs 203, and S′ is a positive integer less than K (S′<K). The tributary ports 2022 of the first WSS 202 different from the tributary ports 2022 coupled to the second WSSs 203 include tributary ports 2022 for add/drop (i.e., tributary ports 2022 coupled to third WSSs described below) and other tributary ports 2022 except the tributary ports 2022 for add/drop and the tributary ports 2022 coupled to the second WSSs 203.

For example, as shown in FIG. 4, D=16, N=2, and K=16. In this case, S′=8. Each set of first WSSs 202 includes an upper first WSS 202 and a lower first WSS 202, and each set of second WSSs 203 includes an upper second WSS 203 and a lower second WSS 203. The 16 sets of first WSSs 202 may be divided into two first clusters 400 (the first cluster 401 and the first cluster 402 respectively); the first cluster 401 includes the first set of first WSSs 202 to the eighth set of first WSSs 202, and the first cluster 402 includes the ninth set of first WSSs 202 to the 16th set of first WSSs 202. The 16 sets of second WSSs 203 may be divided into two second clusters 500 (the second cluster 501 and the second cluster 502 respectively); the second cluster 501 includes the first set of second WSSs 203 to the eighth set of second WSSs 203, and the second cluster 502 includes the ninth set of second WSSs 203 to the 16th set of second WSSs 203.

As for each set of first WSSs 202 in the first cluster 401, eight tributary ports 2022 of the upper first WSS 202 in the set of first WSSs 202 are coupled to tributary ports 2032 of eight upper second WSSs 203 in the second cluster 501 in a one-to-one correspondence, and eight tributary ports 2022 of the lower first WSS 202 in the set of first WSSs 202 are coupled to tributary ports 2032 of eight lower second WSSs 203 in the second cluster 502 in a one-to-one correspondence. For example, as for the first set of first WSSs 202 in the first cluster 401, eight tributary ports 2022 of the upper first WSS 202 in the first set of first WSSs 202 are coupled to first tributary ports 2032 of eight upper second WSSs 203 in the second cluster 501 in a one-to-one correspondence, and eight tributary ports 2022 of the lower first WSS 202 in the first set of first WSSs 202 are coupled to first tributary ports 2032 of eight lower second WSSs 203 in the second cluster 502 in a one-to-one correspondence. As for the eighth set of first WSSs 202 in the first cluster 401, eight tributary ports 2022 of the upper first WSS 202 in the eighth set of first WSSs 202 are coupled to eighth tributary ports 2032 of eight upper second WSSs 203 in the second cluster 501 in a one-to-one correspondence, and eight tributary ports 2022 of the lower first WSS 202 in the eighth set of first WSSs 202 are coupled to eighth tributary ports 2032 of eight lower second WSSs 203 in the second cluster 502 in a one-to-one correspondence.

As for each set of first WSSs 202 in the first cluster 402, eight tributary ports 2022 of the upper first WSS 202 in the set of first WSSs 202 are coupled to tributary ports 2032 of eight upper second WSSs 203 in the second cluster 502 in a one-to-one correspondence, and eight tributary ports 2022 of the lower first WSS 202 in the set of first WSSs 202 are coupled to tributary ports 2032 of eight lower second WSSs 203 in the second cluster 501 in a one-to-one correspondence. For example, as for the ninth set of first WSSs 202 in the first cluster 402, eight tributary ports 2022 of the upper first WSS 202 in the ninth set of first WSSs 202 are coupled to first tributary ports 2032 of eight upper second WSSs 203 in the second cluster 502 in a one-to-one correspondence, and eight tributary ports 2022 of the lower first WSS 202 in the ninth set of first WSSs 202 are coupled to first tributary ports 2032 of eight lower second WSSs 203 in the second cluster 501 in a one-to-one correspondence. As for the 16th set of first WSSs 202 in the first cluster 402, eight tributary ports 2022 of the upper first WSS 202 in the 16th set of first WSSs 202 are coupled to eighth tributary ports 2032 of eight upper second WSSs 203 in the second cluster 502 in a one-to-one correspondence, and eight tributary ports 2022 of the lower first WSS 202 in the 16th set of first WSSs 202 are coupled to eighth tributary ports 2032 of eight lower second WSSs 203 in the second cluster 501 in a one-to-one correspondence.

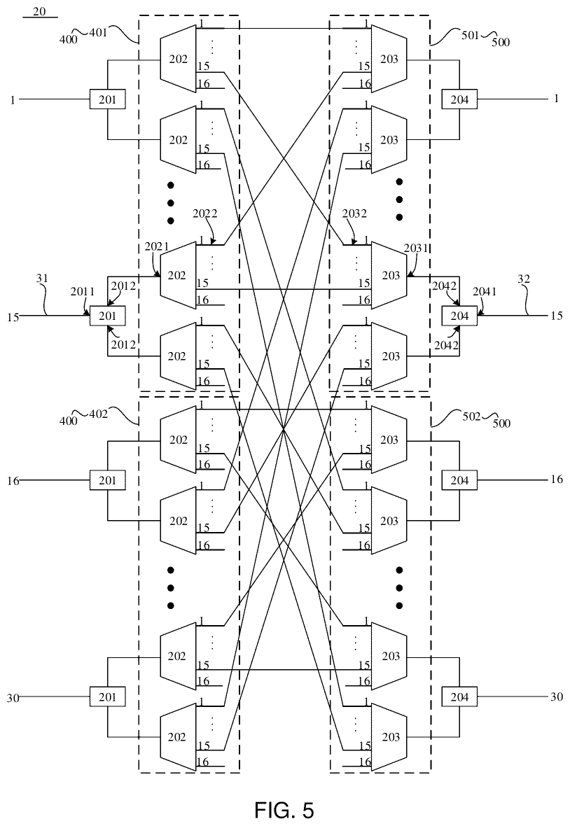

For another example, as shown in FIG. 5, D=30, N=2, and K=16. In this case, S′=1. Each set of first WSSs 202 includes an upper first WSS 202 and a lower first WSS 202, and each set of second WSSs 203 includes an upper second WSS 203 and a lower second WSS 203. The 30 sets of first WSSs 202 may be divided into two first clusters 400 (the first cluster 401 and the first cluster 402 respectively); the first cluster 401 includes the first set of first WSSs 202 to the 15th set of first WSSs 202, and the first cluster 402 includes the 16th set of first WSSs 202 to the 30th set of first WSSs 202. The 30 sets of second WSSs 203 may be divided into two second clusters 500 (the second cluster 501 and the second cluster 502 respectively); the second cluster 501 includes the first set of second WSSs 203 to the 15th set of second WSSs 203, and the second cluster 502 includes the 16th set of second WSSs 203 to the 30th set of second WSSs 203.

As for each set of first WSSs 202 in the first cluster 401, 15 tributary ports 2022 of the upper first WSS 202 in the set of first WSSs 202 are coupled to tributary ports 2032 of 15 upper second WSSs 203 in the second cluster 501 in a one-to-one correspondence, and 15 tributary ports 2022 of the lower first WSS 202 in the set of first WSSs 202 are coupled to tributary ports 2032 of 15 lower second WSSs 203 in the second cluster 502 in a one-to-one correspondence. For example, as for the first set of first WSSs 202 in the first cluster 401, 15 tributary ports 2022 of the upper first WSS 202 in the first set of first WSSs 202 are coupled to first tributary ports 2032 of 15 upper second WSSs 203 in the second cluster 501 in a one-to-one correspondence, and 15 tributary ports 2022 of the lower first WSS 202 in the first set of first WSSs 202 are coupled to first tributary ports 2032 of 15 lower second WSSs 203 in the second cluster 502 in a one-to-one correspondence. As for the 15th set of first WSSs 202 in the first cluster 401, 15 tributary ports 2022 of the upper first WSS 202 in the 15th set of first WSSs 202 are coupled to 15th tributary ports 2032 of 15 upper second WSSs 203 in the second cluster 501 in a one-to-one correspondence, and 15 tributary ports 2022 of the lower first WSS 202 in the 15th set of first WSSs 202 are coupled to 15th tributary ports 2032 of 15 lower second WSSs 203 in the second cluster 502 in a one-to-one correspondence.

As for each set of first WSSs 202 in the first cluster 402, 15 tributary ports 2022 of the upper first WSS 202 in the set of first WSSs 202 are coupled to tributary ports 2032 of 15 upper second WSSs 203 in the second cluster 502 in a one-to-one correspondence, and 15 tributary ports 2022 of the lower first WSS 202 in the set of first WSSs 202 are coupled to tributary ports 2032 of 15 lower second WSSs 203 in the second cluster 501 in a one-to-one correspondence. For example, as for the 16th set of first WSSs 202 in the first cluster 402, 15 tributary ports 2022 of the upper first WSS 202 in the 16th set of first WSSs 202 are coupled to first tributary ports 2032 of 15 upper second WSSs 203 in the second cluster 502 in a one-to-one correspondence, and 15 tributary ports 2022 of the lower first WSS 202 in the 16th set of first WSSs 202 are coupled to first tributary ports 2032 of 15 lower second WSSs 203 in the second cluster 501 in a one-to-one correspondence. As for the 30th set of first WSSs 202 in the first cluster 402, 15 tributary ports 2022 of the upper first WSS 202 in the 30th set of first WSSs 202 are coupled to 15th tributary ports 2032 of 15 upper second WSSs 203 in the second cluster 502 in a one-to-one correspondence, and 15 tributary ports 2022 of the lower first WSS 202 in the 30th set of first WSSs 202 are coupled to 15th tributary ports 2032 of 15 lower second WSSs 203 in the second cluster 501 in a one-to-one correspondence.

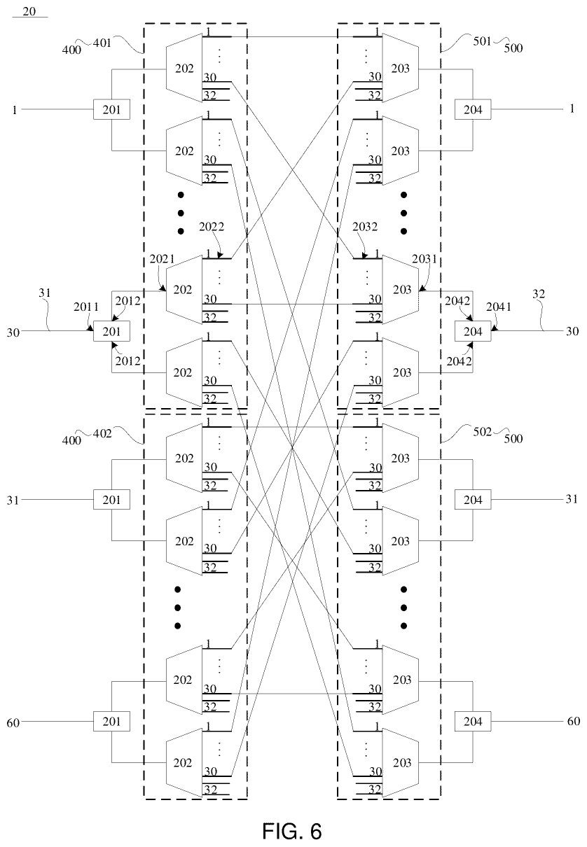

For yet another example, as shown in FIG. 6, D=60, N=2, and K=32. In this case, S′=2. Each set of first WSSs 202 includes an upper first WSS 202 and a lower first WSS 202, and each set of second WSSs 203 includes an upper second WSS 203 and a lower second WSS 203. The 60 sets of first WSSs 202 may be divided into two first clusters 400 (the first cluster 401 and the first cluster 402 respectively); the first cluster 401 includes the first set of first WSSs 202 to the 30th set of first WSSs 202, and the first cluster 402 includes the 31st set of first WSSs 202 to the 60th set of first WSSs 202. The 60 sets of second WSSs 203 may be divided into two second clusters 500 (the second cluster 501 and the second cluster 502 respectively); the second cluster 501 includes the first set of second WSSs 203 to the 30th set of second WSSs 203, and the second cluster 502 includes the 31st set of second WSSs 203 to the 60th set of second WSSs 203.

As for each set of first WSSs 202 in the first cluster 401, 30 tributary ports 2022 of the upper first WSS 202 in the set of first WSSs 202 are coupled to tributary ports 2032 of 30 upper second WSSs 203 in the second cluster 501 in a one-to-one correspondence, and 30 tributary ports 2022 of the lower first WSS 202 in the set of first WSSs 202 are coupled to tributary ports 2032 of 30 lower second WSSs 203 in the second cluster 502 in a one-to-one correspondence. For example, as for the first set of first WSSs 202 in the first cluster 401, 30 tributary ports 2022 of the upper first WSS 202 in the first set of first WSSs 202 are coupled to first tributary ports 2032 of 30 upper second WSSs 203 in the second cluster 501 in a one-to-one correspondence, and 30 tributary ports 2022 of the lower first WSS 202 in the first set of first WSSs 202 are coupled to first tributary ports 2032 of 30 lower second WSSs 203 in the second cluster 502 in a one-to-one correspondence. As for the 30th set of first WSSs 202 in the first cluster 401, 30 tributary ports 2022 of the upper first WSS 202 in the 30th set of first WSSs 202 are coupled to 30th tributary ports 2032 of 30 upper second WSSs 203 in the second cluster 501 in a one-to-one correspondence, and 30 tributary ports 2022 of the lower first WSS 202 in the 30th set of first WSSs 202 are coupled to 30th tributary ports 2032 of 30 lower second WSSs 203 in the second cluster 502 in a one-to-one correspondence.

As for each set of first WSSs 202 in the first cluster 402, 30 tributary ports 2022 of the upper first WSS 202 in the set of first WSSs 202 are coupled to tributary ports 2032 of 30 upper second WSSs 203 in the second cluster 502 in a one-to-one correspondence, and 30 tributary ports 2022 of the lower first WSS 202 in the set of first WSSs 202 are coupled to tributary ports 2032 of 30 lower second WSSs 203 in the second cluster 501 in a one-to-one correspondence. For example, as for the 31st set of first WSSs 202 in the first cluster 402, 30 tributary ports 2022 of the upper first WSS 202 in the 31st set of first WSSs 202 are coupled to first tributary ports 2032 of 30 upper second WSSs 203 in the second cluster 502 in a one-to-one correspondence, and 30 tributary ports 2022 of the lower first WSS 202 in the 31st set of first WSSs 202 are coupled to first tributary ports 2032 of 30 lower second WSSs 203 in the second cluster 501 in a one-to-one correspondence. As for the 60th set of first WSSs 202 in the first cluster 402, 30 tributary ports 2022 of the upper first WSS 202 in the 60th set of first WSSs 202 are coupled to 30th tributary ports 2032 of 30 upper second WSSs 203 in the second cluster 502 in a one-to-one correspondence, and 30 tributary ports 2022 of the lower first WSS 202 in the 60th set of first WSSs 202 are coupled to 30th tributary ports 2032 of 30 lower second WSSs 203 in the second cluster 501 in a one-to-one correspondence.

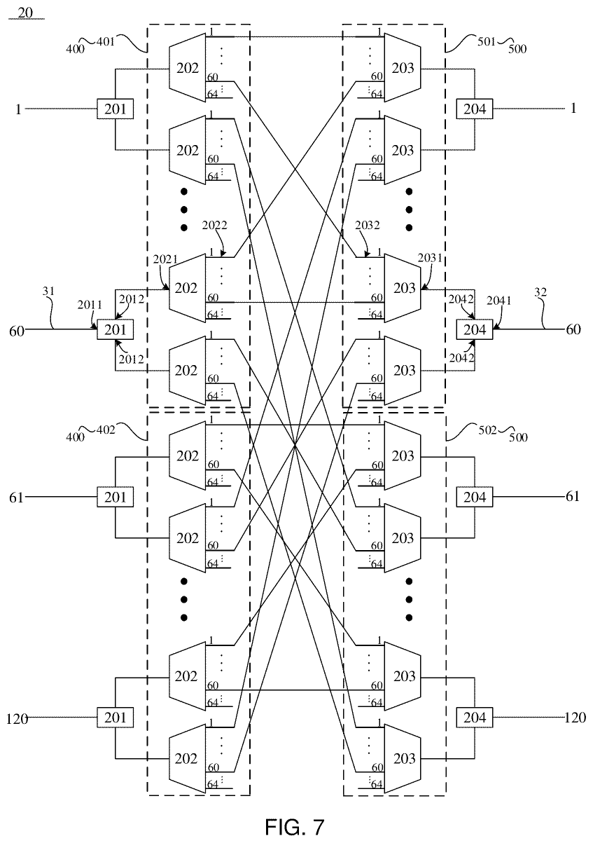

For yet another example, as shown in FIG. 7, D=120, N=2, and K=64. In this case, S′=4. Each set of first WSSs 202 includes an upper first WSS 202 and a lower first WSS 202, and each set of second WSSs 203 includes an upper second WSS 203 and a lower second WSS 203. The 120 sets of first WSSs 202 may be divided into two first clusters 400 (the first cluster 401 and the first cluster 402 respectively); the first cluster 401 includes the first set of first WSSs 202 to the 60th set of first WSSs 202, and the first cluster 402 includes the 61st set of first WSSs 202 to the 120th set of first WSSs 202. The 120 sets of second WSSs 203 may be divided into two second clusters 500 (the second cluster 501 and the second cluster 502 respectively); the second cluster 501 includes the first set of second WSSs 203 to the 60th set of second WSSs 203, and the second cluster 502 includes the 61st set of second WSSs 203 to the 120th set of second WSSs 203.

As for each set of first WSSs 202 in the first cluster 401, 60 tributary ports 2022 of the upper first WSS 202 in the set of first WSSs 202 are coupled to tributary ports 2032 of 60 upper second WSSs 203 in the second cluster 501 in a one-to-one correspondence, and 60 tributary ports 2022 of the lower first WSS 202 in the set of first WSSs 202 are coupled to tributary ports 2032 of 60 lower second WSSs 203 in the second cluster 502 in a one-to-one correspondence. For example, as for the first set of first WSSs 202 in the first cluster 401, 60 tributary ports 2022 of the upper first WSS 202 in the first set of first WSSs 202 are coupled to first tributary ports 2032 of 60 upper second WSSs 203 in the second cluster 501 in a one-to-one correspondence, and 60 tributary ports 2022 of the lower first WSS 202 in the first set of first WSSs 202 are coupled to first tributary ports 2032 of 60 lower second WSSs 203 in the second cluster 502 in a one-to-one correspondence. As for the 60th set of first WSSs 202 in the first cluster 401, 60 tributary ports 2022 of the upper first WSS 202 in the 60th set of first WSSs 202 are coupled to 60th tributary ports 2032 of 60 upper second WSSs 203 in the second cluster 501 in a one-to-one correspondence, and 60 tributary ports 2022 of the lower first WSS 202 in the 60th set of first WSSs 202 are coupled to 60th tributary ports 2032 of 60 lower second WSSs 203 in the second cluster 502 in a one-to-one correspondence.

As for each set of first WSSs 202 in the first cluster 402, 60 tributary ports 2022 of the upper first WSS 202 in the set of first WSSs 202 are coupled to tributary ports 2032 of 60 upper second WSSs 203 in the second cluster 502 in a one-to-one correspondence, and 60 tributary ports 2022 of the lower first WSS 202 in the set of first WSSs 202 are coupled to tributary ports 2032 of 60 lower second WSSs 203 in the second cluster 501 in a one-to-one correspondence. For example, as for the 61st set of first WSSs 202 in the first cluster 402, 60 tributary ports 2022 of the upper first WSS 202 in the 61st set of first WSSs 202 are coupled to first tributary ports 2032 of 60 upper second WSSs 203 in the second cluster 502 in a one-to-one correspondence, and 60 tributary ports 2022 of the lower first WSS 202 in the 61st set of first WSSs 202 are coupled to first tributary ports 2032 of 60 lower second WSSs 203 in the second cluster 501 in a one-to-one correspondence. As for the 120th set of first WSSs 202 in the first cluster 402, 60 tributary ports 2022 of the upper first WSS 202 in the 120th set of first WSSs 202 are coupled to 60th tributary ports 2032 of 60 upper second WSSs 203 in the second cluster 502 in a one-to-one correspondence, and 60 tributary ports 2022 of the lower first WSS 202 in the 120th set of first WSSs 202 are coupled to 60th tributary ports 2032 of 60 lower second WSSs 203 in the second cluster 501 in a one-to-one correspondence.

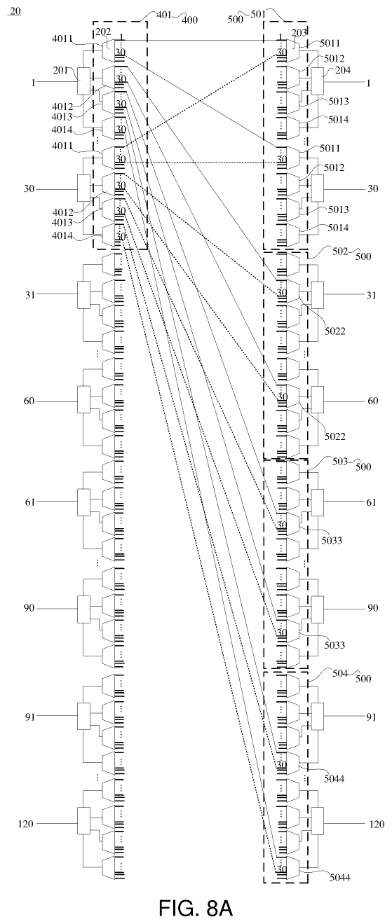

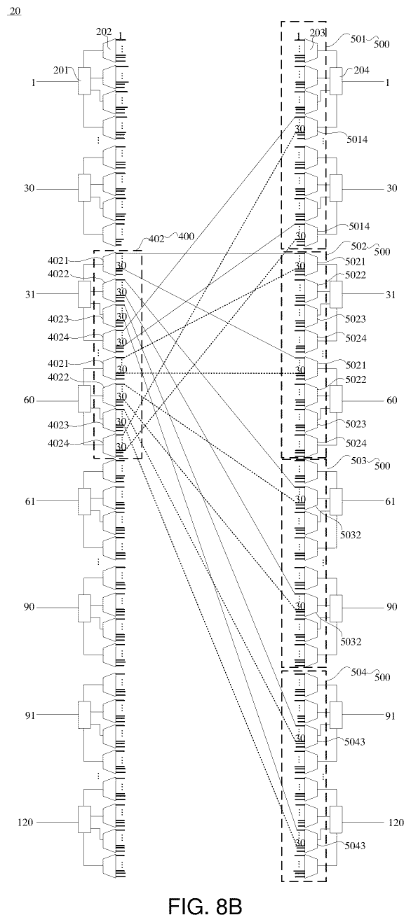

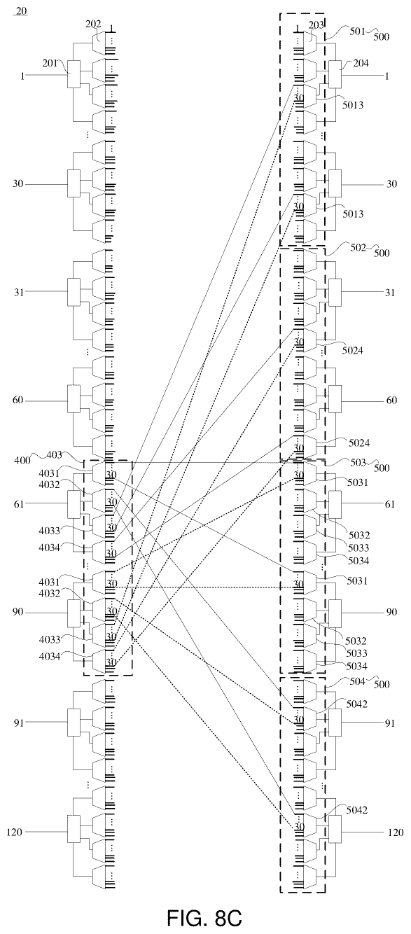

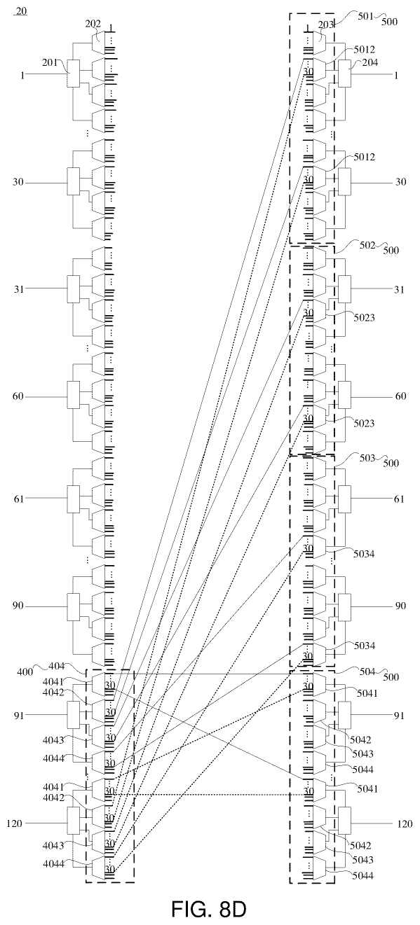

For yet another example, as shown in FIGS. 8A to 8D, D=120, N=4, and K=32. In this case, S′=2. Each set of first WSSs 202 includes a first first WSS 202, a second first WSS 202, a third first WSS 202, and a fourth first WSS 202 (from top to bottom). The 120 sets of first WSSs 202 may be divided into four first clusters 400 (the first cluster 401, the first cluster 402, the first cluster 403, and the first cluster 404 respectively); the first cluster 401 includes the first set of first WSSs 202 to the 30th set of first WSSs 202, the first cluster 402 includes the 31st set of first WSSs 202 to the 60th set of first WSSs 202, the first cluster 403 includes the 61st set of first WSSs 202 to the 90th set of first WSSs 202, and the first cluster 404 includes the 91st set of first WSSs 202 to the 120th set of first WSSs 202.

Referring to FIG. 8A, the first cluster 401 includes a first sub-cluster 4011, a second sub-cluster 4012, a third sub-cluster 4013 and a fourth sub-cluster 4014. The first sub-cluster 4011 includes 30 first WSSs 202, each being a first first WSS 202 in a set of first WSSs 202 in the first cluster 401; the second sub-cluster 4012 includes 30 first WSSs 202, each being a second first WSS 202 in a set of first WSSs 202 in the first cluster 401; the third sub-cluster 4013 includes 30 first WSSs 202, each being a third first WSS 202 in a set of first WSSs 202 in the first cluster 401; and the fourth sub-cluster 4014 includes 30 first WSSs 202, each being a fourth first WSS 202 in a set of first WSSs 202 in the first cluster 401.

Referring to FIG. 8B, the first cluster 402 includes a fifth sub-cluster 4021, a sixth sub-cluster 4022, a seventh sub-cluster 4023 and an eighth sub-cluster 4024. The fifth sub-cluster 4021 includes 30 first WSSs 202, each being a first first WSS 202 in a set of first WSSs 202 in the first cluster 402; the sixth sub-cluster 4022 includes 30 first WSSs 202, each being a second first WSS 202 in a set of first WSSs 202 in the first cluster 402; the seventh sub-cluster 4023 includes 30 first WSSs 202, each being a third first WSS 202 in a set of first WSSs 202 in the first cluster 402; and the eighth sub-cluster 4024 includes 30 first WSSs 202, each being a fourth first WSS 202 in a set of first WSSs 202 in the first cluster 402.

Referring to FIG. 8C, the first cluster 403 includes a ninth sub-cluster 4031, a tenth sub-cluster 4032, an 11th sub-cluster 4033 and a 12th sub-cluster 4034. The ninth sub-cluster 4031 includes 30 first WSSs 202, each being a first first WSS 202 in a set of first WSSs 202 in the first cluster 403; the tenth sub-cluster 4032 includes 30 first WSSs 202, each being a second first WSS 202 in a set of first WSSs 202 in the first cluster 403; the 11th sub-cluster 4033 includes 30 first WSSs 202, each being a third first WSS 202 in a set of first WSSs 202 in the first cluster 403; and the 12th sub-cluster 4034 includes 30 first WSSs 202, each being a fourth first WSS 202 in a set of first WSSs 202 in the first cluster 403.

Referring to FIG. 8D, the first cluster 404 includes a 13th sub-cluster 4041, a 14th sub-cluster 4042, a 15th sub-cluster 4043 and a 16th sub-cluster 4044. The 13th sub-cluster 4041 includes 30 first WSSs 202, each being a first first WSS 202 in a set of first WSSs 202 in the first cluster 404; the 14th sub-cluster 4042 includes 30 first WSSs 202, each being a second first WSS 202 in a set of first WSSs 202 in the first cluster 404; the 15th sub-cluster 4043 includes 30 first WSSs 202, each being a third first WSS 202 in a set of first WSSs 202 in the first cluster 404; and the 16th sub-cluster 4044 includes 30 first WSSs 202, each being a fourth first WSS 202 in a set of first WSSs 202 in the first cluster 404.

Each set of second WSSs 203 includes a first second WSS 203, a second second WSS 203, a third second WSS 203, and a fourth second WSS 203 (from top to bottom). The 120 sets of second WSSs 203 may be divided into four second clusters 500 (the second cluster 501, the second cluster 502, the second cluster 503, and the second cluster 504 respectively); the second cluster 501 includes the first set of second WSSs 203 to the 30th set of second WSSs 203, the second cluster 502 includes the 31st set of second WSSs 203 to the 60th set of second WSSs 203, the second cluster 503 includes the 61st set of second WSSs 203 to the 90th set of second WSSs 203, and the second cluster 504 includes the 91st set of second WSSs 203 to the 120th set of second WSSs 203.

Referring to FIG. 8A, the second cluster 501 includes a 17th sub-cluster 5011, an 18th sub-cluster 5012, a 19th sub-cluster 5013 and a 20th sub-cluster 5014. The 17th sub-cluster 5011 includes 30 second WSSs 203, each being a first second WSS 203 in a set of second WSSs 203 in the second cluster 501; the 18th sub-cluster 5012 includes 30 second WSSs 203, each being a second second WSS 203 in a set of second WSSs 203 in the second cluster 501; the 19th sub-cluster 5013 includes 30 second WSSs 203, each being a third second WSS 203 in a set of second WSSs 203 in the second cluster 501; and the 20th sub-cluster 5014 includes 30 second WSSs 203, each being a fourth second WSS 203 in a set of second WSSs 203 in the second cluster 501.

Referring to FIG. 8B, the second cluster 502 includes a 21st sub-cluster 5021, a 22nd sub-cluster 5022, a 23rd sub-cluster 5023 and a 24th sub-cluster 5024. The 21st sub-cluster 5021 includes 30 second WSSs 203, each being a first second WSS 203 in a set of second WSSs 203 in the second cluster 502; the 22nd sub-cluster 5022 includes 30 second WSSs 203, each being a second second WSS 203 in a set of second WSSs 203 in the second cluster 502; the 23rd sub-cluster 5023 includes 30 second WSSs 203, each being a third second WSS 203 in a set of second WSSs 203 in the second cluster 502; and the 24th sub-cluster 5024 includes 30 second WSSs 203, each being a fourth second WSS 203 in a set of second WSSs 203 in the second cluster 502.

Referring to FIG. 8C, the second cluster 503 includes a 25th sub-cluster 5031, a 26th sub-cluster 5032, a 27th sub-cluster 5033 and a 28th sub-cluster 5034. The 25th sub-cluster 5031 includes 30 second WSSs 203, each being a first second WSS 203 in a set of second WSSs 203 in the second cluster 503; the 26th sub-cluster 5032 includes 30 second WSSs 203, each being a second second WSS 203 in a set of second WSSs 203 in the second cluster 503; the 27th sub-cluster 5033 includes 30 second WSSs 203, each being a third second WSS 203 in a set of second WSSs 203 in the second cluster 503; and the 28th sub-cluster 5034 includes 30 second WSSs 203, each being a fourth second WSS 203 in a set of second WSSs 203 in the second cluster 503.

Referring to FIG. 8D, the second cluster 504 includes a 29th sub-cluster 5041, a 30th sub-cluster 5042, a 31st sub-cluster 5043 and a 32nd sub-cluster 5044. The 29th sub-cluster 5041 includes 30 second WSSs 203, each being a first second WSS 203 in a set of second WSSs 203 in the second cluster 504; the 30th sub-cluster 5042 includes 30 second WSSs 203, each being a second second WSS 203 in a set of second WSSs 203 in the second cluster 504; the 31st sub-cluster 5043 includes 30 second WSSs 203, each being a third second WSS 203 in a set of second WSSs 203 in the second cluster 504; and the 32nd sub-cluster 5044 includes 30 second WSSs 203, each being a fourth second WSS 203 in a set of second WSSs 203 in the second cluster 504.

As shown in FIGS. 8A, 30 tributary ports of each first WSS 202 in the first sub-cluster 4011 are coupled to 30 second WSSs 203 in the 17th sub-cluster 5011 in a one-to-one correspondence, 30 tributary ports of each first WSS 202 in the second sub-cluster 4012 are coupled to 30 second WSSs 203 in the 22nd sub-cluster 5022 in a one-to-one correspondence, 30 tributary ports of each first WSS 202 in the third sub-cluster 4013 are coupled to 30 second WSSs 203 in the 27th sub-cluster 5033 in a one-to-one correspondence, and 30 tributary ports of each first WSS 202 in the fourth sub-cluster 4014 are coupled to 30 second WSSs 203 in the 32nd sub-cluster 5044 in a one-to-one correspondence. For example, as for the first sub-cluster 4011, 30 tributary ports 2022 of the first first WSS 202 in the first set of first WSSs 202 are coupled to first tributary ports 2032 of 30 second WSSs 203 in the 17th sub-cluster 5011 in a one-to-one correspondence, and 30 tributary ports 2022 of the first first WSS 202 in the 30th set of first WSSs 202 are coupled to 30th tributary ports 2032 of 30 second WSSs 203 in the 17th sub-cluster 5011 in a one-to-one correspondence. As for the second sub-cluster 4012, 30 tributary ports 2022 of the second first WSS 202 in the first set of first WSSs 202 are coupled to first tributary ports 2032 of 30 second WSSs 203 in the 22nd sub-cluster 5022 in a one-to-one correspondence, and 30 tributary ports 2022 of the second first WSS 202 in the 30th set of first WSSs 202 are coupled to 30th tributary ports 2032 of 30 second WSSs 203 in the 22nd sub-cluster 5022 in a one-to-one correspondence. As for the third sub-cluster 4013, 30 tributary ports 2022 of the third first WSS 202 in the first set of first WSSs 202 are coupled to first tributary ports 2032 of 30 second WSSs 203 in the 27th sub-cluster 5033 in a one-to-one correspondence, and 30 tributary ports 2022 of the third first WSS 202 in the 30th set of first WSSs 202 are coupled to 30th tributary ports 2032 of 30 second WSSs 203 in the 27th sub-cluster 5033 in a one-to-one correspondence. As for the fourth sub-cluster 4014, 30 tributary ports 2022 of the fourth first WSS 202 in the first set of first WSSs 202 are coupled to first tributary ports 2032 of 30 second WSSs 203 in the 32nd sub-cluster 5044 in a one-to-one correspondence, and 30 tributary ports 2022 of the fourth first WSS 202 in the 30th set of first WSSs 202 are coupled to 30th tributary ports 2032 of 30 second WSSs 203 in the 32nd sub-cluster 5044 in a one-to-one correspondence.

As shown in FIGS. 8B, 30 tributary ports of each first WSS 202 in the fifth sub-cluster 4021 are coupled to 30 second WSSs 203 in the 21st sub-cluster 5021 in a one-to-one correspondence, 30 tributary ports of each first WSS 202 in the sixth sub-cluster 4022 are coupled to 30 second WSSs 203 in the 26th sub-cluster 5032 in a one-to-one correspondence, 30 tributary ports of each first WSS 202 in the seventh sub-cluster 4023 are coupled to 30 second WSSs 203 in the 31st sub-cluster 5043 in a one-to-one correspondence, and 30 tributary ports of each first WSS 202 in the eighth sub-cluster 4024 are coupled to 30 second WSSs 203 in the 20th sub-cluster 5014 in a one-to-one correspondence. For example, as for the fifth sub-cluster 4021, 30 tributary ports 2022 of the first first WSS 202 in the 31st set of first WSSs 202 are coupled to first tributary ports 2032 of 30 second WSSs 203 in the 21st sub-cluster 5021 in a one-to-one correspondence, and 30 tributary ports 2022 of the first first WSS 202 in the 60th set of first WSSs 202 are coupled to 30th tributary ports 2032 of 30 second WSSs 203 in the 21st sub-cluster 5021 in a one-to-one correspondence. As for the sixth sub-cluster 4022, 30 tributary ports 2022 of the second first WSS 202 in the 31st set of first WSSs 202 are coupled to first tributary ports 2032 of 30 second WSSs 203 in the 26th sub-cluster 5032 in a one-to-one correspondence, and 30 tributary ports 2022 of the second first WSS 202 in the 60th set of first WSSs 202 are coupled to 30th tributary ports 2032 of 30 second WSSs 203 in the 26th sub-cluster 5032 in a one-to-one correspondence. As for the seventh sub-cluster 4023, 30 tributary ports 2022 of the third first WSS 202 in the 31st set of first WSSs 202 are coupled to first tributary ports 2032 of 30 second WSSs 203 in the 31st sub-cluster 5043 in a one-to-one correspondence, and 30 tributary ports 2022 of the third first WSS 202 in the 60th set of first WSSs 202 are coupled to 30th tributary ports 2032 of 30 second WSSs 203 in the 31st sub-cluster 5043 in a one-to-one correspondence. As for the eighth sub-cluster 4024, 30 tributary ports 2022 of the fourth first WSS 202 in the 31st set of first WSSs 202 are coupled to first tributary ports 2032 of 30 second WSSs 203 in the 20th sub-cluster 5014 in a one-to-one correspondence, and 30 tributary ports 2022 of the fourth first WSS 202 in the 60th set of first WSSs 202 are coupled to 30th tributary ports 2032 of 30 second WSSs 203 in the 20th sub-cluster 5014 in a one-to-one correspondence.

As shown in FIGS. 8C, 30 tributary ports of each first WSS 202 in the ninth sub-cluster 4031 are coupled to 30 second WSSs 203 in the 25th sub-cluster 5031 in a one-to-one correspondence, 30 tributary ports of each first WSS 202 in the tenth sub-cluster 4032 are coupled to 30 second WSSs 203 in the 30th sub-cluster 5042 in a one-to-one correspondence, 30 tributary ports of each first WSS 202 in the 11th sub-cluster 4033 are coupled to 30 second WSSs 203 in the 19th sub-cluster 5013 in a one-to-one correspondence, and 30 tributary ports of each first WSS 202 in the 12th sub-cluster 4034 are coupled to 30 second WSSs 203 in the 24th sub-cluster 5024 in a one-to-one correspondence. For example, as for the ninth sub-cluster 4031, 30 tributary ports 2022 of the first first WSS 202 in the 61st set of first WSSs 202 are coupled to first tributary ports 2032 of 30 second WSSs 203 in the 25th sub-cluster 5031 in a one-to-one correspondence, and 30 tributary ports 2022 of the first first WSS 202 in the 90th set of first WSSs 202 are coupled to 30th tributary ports 2032 of 30 second WSSs 203 in the 25th sub-cluster 5031 in a one-to-one correspondence. As for the tenth sub-cluster 4032, 30 tributary ports 2022 of the second first WSS 202 in the 61st set of first WSSs 202 are coupled to first tributary ports 2032 of 30 second WSSs 203 in the 30th sub-cluster 5042 in a one-to-one correspondence, and 30 tributary ports 2022 of the second first WSS 202 in the 90th set of first WSSs 202 are coupled to 30th tributary ports 2032 of 30 second WSSs 203 in the 30th sub-cluster 5042 in a one-to-one correspondence. As for the 11th sub-cluster 4033, 30 tributary ports 2022 of the third first WSS 202 in the 61st set of first WSSs 202 are coupled to first tributary ports 2032 of 30 second WSSs 203 in the 19th sub-cluster 5013 in a one-to-one correspondence, and 30 tributary ports 2022 of the third first WSS 202 in the 90th set of first WSSs 202 are coupled to 30th tributary ports 2032 of 30 second WSSs 203 in the 19th sub-cluster 5013 in a one-to-one correspondence. As for the 12th sub-cluster 4034, 30 tributary ports 2022 of the fourth first WSS 202 in the 61st set of first WSSs 202 are coupled to first tributary ports 2032 of 30 second WSSs 203 in the 24th sub-cluster 5024 in a one-to-one correspondence, and 30 tributary ports 2022 of the fourth first WSS 202 in the 90th set of first WSSs 202 are coupled to 30th tributary ports 2032 of 30 second WSSs 203 in the 24th sub-cluster 5024 in a one-to-one correspondence.

As shown in FIGS. 8D, 30 tributary ports of each first WSS 202 in the 13th sub-cluster 4041 are coupled to 30 second WSSs 203 in the 29th sub-cluster 5041 in a one-to-one correspondence, 30 tributary ports of each first WSS 202 in the 14th sub-cluster 4042 are coupled to 30 second WSSs 203 in the 18th sub-cluster 5012 in a one-to-one correspondence, 30 tributary ports of each first WSS 202 in the 15th sub-cluster 4043 are coupled to 30 second WSSs 203 in the 23rd sub-cluster 5023 in a one-to-one correspondence, and 30 tributary ports of each first WSS 202 in the 16th sub-cluster 4044 are coupled to 30 second WSSs 203 in the 28th sub-cluster 5034 in a one-to-one correspondence. For example, as for the 13th sub-cluster 4041, 30 tributary ports 2022 of the first first WSS 202 in the 91st set of first WSSs 202 are coupled to first tributary ports 2032 of 30 second WSSs 203 in the 29th sub-cluster 5041 in a one-to-one correspondence, and 30 tributary ports 2022 of the first first WSS 202 in the 120th set of first WSSs 202 are coupled to 30th tributary ports 2032 of 30 second WSSs 203 in the 29th sub-cluster 5041 in a one-to-one correspondence. As for the 14th sub-cluster 4042, 30 tributary ports 2022 of the second first WSS 202 in the 91st set of first WSSs 202 are coupled to first tributary ports 2032 of 30 second WSSs 203 in the 18th sub-cluster 5012 in a one-to-one correspondence, and 30 tributary ports 2022 of the second first WSS 202 in the 120th set of first WSSs 202 are coupled to 30th tributary ports 2032 of 30 second WSSs 203 in the 18th sub-cluster 5012 in a one-to-one correspondence. As for the 15th sub-cluster 4043, 30 tributary ports 2022 of the third first WSS 202 in the 91st set of first WSSs 202 are coupled to first tributary ports 2032 of 30 second WSSs 203 in the 23rd sub-cluster 5023 in a one-to-one correspondence, and 30 tributary ports 2022 of the third first WSS 202 in the 120th set of first WSSs 202 are coupled to 30th tributary ports 2032 of 30 second WSSs 203 in the 23rd sub-cluster 5023 in a one-to-one correspondence. As for the 16th sub-cluster 4044, 30 tributary ports 2022 of the fourth first WSS 202 in the 91st set of first WSSs 202 are coupled to first tributary ports 2032 of 30 second WSSs 203 in the 28th sub-cluster 5034 in a one-to-one correspondence, and 30 tributary ports 2022 of the fourth first WSS 202 in the 120th set of first WSSs 202 are coupled to 30th tributary ports 2032 of 30 second WSSs 203 in the 28th sub-cluster 5034 in a one-to-one correspondence.

In the above examples, by setting D, N and K to reasonable values, it may be possible to achieve optical configuration of the node.

In some embodiments, the splitter 201 is a WSS with one common port and N tributary ports. In this way, a small-sized WSS may be used as the splitter 201.

In some embodiments, the combiner 204 is a WSS with one common port and N tributary ports. In this way, a small-sized WSS may be used as the combiner 204.

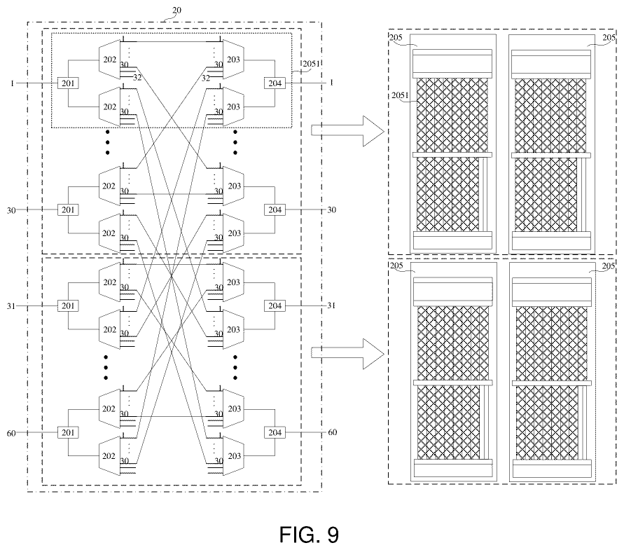

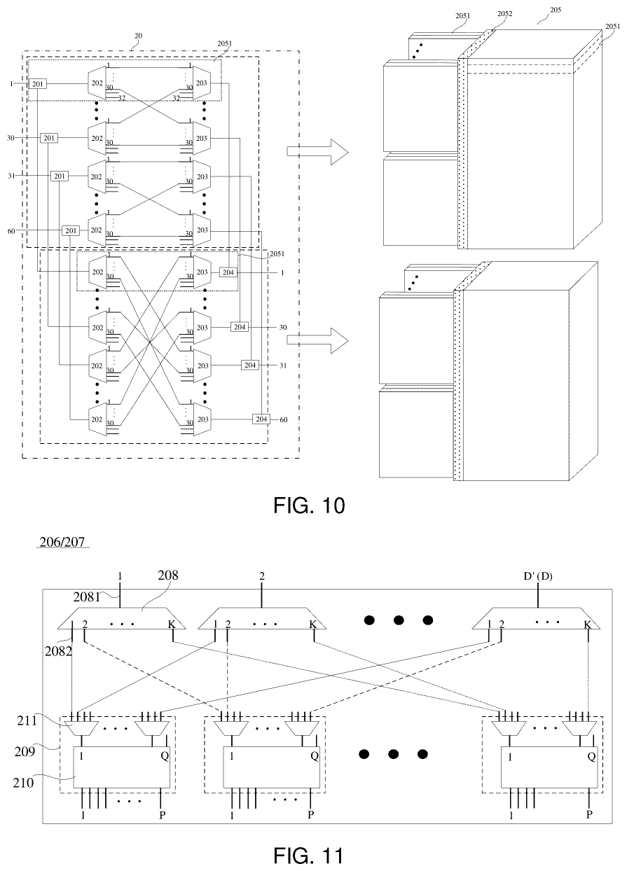

In some embodiments, as shown in FIGS. 9 and 10, the ROADM node 20 includes a plurality of line card chassis 205, and each line card chassis 205 includes a plurality of line cards 2051. The line card 2051 includes at least one first WSS 202 of the D sets of first WSSs 202 and/or at least one second WSS 203 of the D sets of second WSSs 203.

Each line card 2051 may occupy at least one slot of the line card chassis 205.

In some implementations, as shown in FIG. 9, a line card 2051 may include two first WSSs 202, two second WSSs 203, one splitter 201, and one combiner 204. For example, each line card 2051 corresponds to one degree (direction); that is, each line card 2051 includes one splitter 201, two first WSSs 202, two second WSSs 203, and one combiner 204 in one direction.

With the first WSS 202 and the second WSS 203 both having 32 tributary ports, and the splitter 201 and the combiner 204 both having two tributary ports as an example, as shown in FIG. 9, the line card chassis 205 may be a 32-slot chassis, with each line card 2051 occupying two slots. In this way, it may be possible to use four line card chassis 205 to house all the splitters 201, first WSSs 202, second WSSs 203, and combiners 204 in 60 directions. Each line card 2051 may communicate with other line cards 2051 located in the same line card chassis 205 through a backplane, or may communicate with line cards 2051 located in other line card chassis through fibers, e.g., ribbon cables.

In some implementations, as shown in FIG. 10, a line card 2051 may include one first WSS 202, one second WSS 203, and one splitter 201. For example, one first WSS 202, one second WSS 203, and one splitter 201 in each direction are located in one line card 2051.

In some implementations, as shown in FIG. 10, a line card 2051 may include one first WSS 202, one second WSS 203, and one combiner 204. For example, one first WSS 202, one second WSS 203, and one combiner 204 in each direction are located in one line card 2051.

Still with the first WSS 202 and the second WSS 203 both having 32 tributary ports, and the splitter 201 and the combiner 204 both having two tributary ports as an example, as shown in FIG. 10, the line card chassis 205 may be a large chassis (e.g., a double-depth chassis); the upper first WSS 202 of each set of first WSSs 202, the upper second WSS 203 of each set of second WSSs 203, and the splitter 201 may be placed in one line card chassis 205, and the lower first WSS 202 of each set of first WSSs 202, the lower second WSS 203 of each set of second WSSs 203, and the combiner 204 may be placed in another line card chassis 205. In this way, it may be possible to use two chassis to house all the splitters 201, first WSSs 202, second WSSs 203 and combiners 204 in 60 directions.

In the same double-depth chassis, some line cards 2051 may be located on one side of a mid-plane 2052, and remaining line cards 2051 may be located on the other side of the mid-plane 2052. These line cards 2051 may be coupled through the mid-plane 2052. The first WSS 202 and the splitter 201 that are in the same direction and in different line card chassis 205 may be coupled through a connector on a faceplate, and the second WSS 203 and the combiner 204 that are in the same direction and in different line card chassis 205 may be coupled through a connector on the faceplate. The faceplate may be located in one of the chassis.

For example, the double-depth chassis may have a depth of 600 mm from the side of the mid-plane 2052 on which the line cards 2051 are provided to the other side which is opposite to this side.

In some implementations, the line card 2051 includes two first WSSs 202 and one splitter 201. For example, two first WSSs 202 and one splitter 201 in each direction are located in one line card 2051.

In some implementations, the line card 2051 includes two second WSSs 203 and one combiner 204. For example, two second WSSs 203 and one combiner 204 in each direction are located in one line card 2051.

In these implementations, the line card chassis 205 may be an ordinary chassis as shown in FIG. 9, or may be a large chassis as shown in FIG. 10. Regarding this, reference may be made to the above description.

In the embodiments of the present disclosure, a conventional chassis may be used to house the components in the ROADM node. As such, the customers may be able to retain their investments in the equipment they purchased and maintain forward and backward compatibility, at least for one generation, and may also be able to keep the performance as they scale their network. On this basis, by adopting a WSS of conventional size, it may be possible to scale the degree of the node with a low cost. In addition, this may allow for flexibility in designing the line cards 2051 in the line card chassis 205.

In some examples, the ROADM node 20 may further include an add-drop component for adding or dropping wavelengths. The add-drop component includes, but is not limited to, an add-drop component that can be implemented in colorless, directionless and contentionless (CDC) or an add-drop component that can be implemented in colorless/directionless (CD).

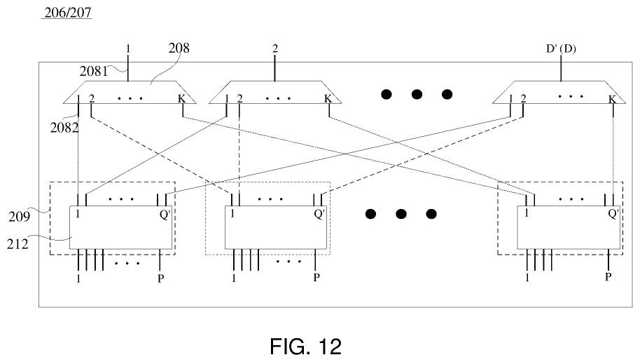

It will be noted that, the add-drop component for dropping (e.g., add-drop component 206 in FIGS. 11 and 12) and the add-drop component for adding (e.g., add-drop component 207 in FIGS. 11 and 12) are described below, both of which have the same structure, but the direction of signals is different. In this case, the add-drop component for dropping can be referred to as a drop component, and the add-drop component for adding can be referred to as an add component. For the drop component, signals arrive at common ports of third WSSs of the drop component (which are described below). For the add component, signals depart the common ports of the third WSSs.

In some embodiments, as shown in FIGS. 11 and 12, the ROADM node 20 further includes at least one add-drop component 206 coupled to S tributary ports 2022 of the first WSS 202. S is less than K (S<K), and S is a positive integer. In the first WSS 202, the S tributary ports 2022 coupled to the at least one add-drop component 206 are different from tributary ports 2022 coupled to tributary ports 2032 of second WSSs 203.

In a case where D/N tributary ports 2022 of the first WSS 202 are coupled to tributary ports 2032 of the second WSSs 203, S≤K-D/N. In a case where the first fiber 31 is an input fiber and the second fiber is an output fiber, the at least one add-drop component 206 coupled to the S tributary ports 2022 of the first WSS 202 is used for dropping wavelengths.

In some embodiments, as shown in FIGS. 11 and 12, the ROADM node 20 further includes at least one add-drop component 207 coupled to T tributary ports 2032 of the second WSS 203. T is less than K (T<K), and T is a positive integer. In the second WSS 203, the T tributary ports 2032 coupled to the at least one add-drop component 207 are different from tributary ports 2032 coupled to tributary ports 2022 of first WSSs 202.

In a case where D/N tributary ports 2032 of the second WSS 203 are coupled to tributary ports 2022 of the first WSSs 202, T≤K−D/N. In a case where the first fiber 31 is an input fiber and the second fiber is an output fiber, the at least one add-drop component 207 coupled to the T tributary ports 2032 of the second WSS 203 is used for adding wavelengths.

By providing the add-drop component 206 and the add-drop component 207, the ROADM node 20 may be able to add and drop wavelengths flexibly.

Only the structure of the add-drop component 206 will be described below. As for the structure of the add-drop component 207, reference may be made to description of the add-drop component 206.

In some implementations, as shown in FIGS. 11 and 12, the add-drop component 206 may include D′ third WSSs 208 and K add-drop cards 209. A third WSS 208 has one common port 2081 and K tributary ports 2082. In the add-drop component 206, common ports 2081 of the D′ third WSSs 208 are coupled to D′ tributary ports 2022 of multiple first WSSs 202 in a one-to-one correspondence, and the K tributary ports 2082 of the third WSS 208 are coupled to the K add-drop cards 209 respectively. D′ is a positive integer. Through such arrangement, the first WSSs 202 coupled to the common ports 2081 of the D′ third WSSs 208 can simultaneously perform dropping wavelengths.

For example, the third WSS 208 has one common port 2081 and 32 tributary ports 2082.

In a case where S is greater than 1 (S≥1), the S tributary ports 2022 of the first WSS 202 may be coupled to the same add-drop component 206; or, the S tributary ports 2022 of the first WSS 202 may be coupled to S add-drop components 206 respectively; or, at least one of the S tributary ports 2022 of the first WSS 202 is coupled to one add-drop component 206, and the rest of the S tributary ports 2022 of the first WSS 202 are coupled to at least one add-drop component 206.

In some examples, D′ is equal to D (D′=D), and common ports 2081 of the D third WSSs 208 in the add-drop component 206 are coupled to D tributary ports 2022 of D first WSSs 202 in a one-to-one correspondence. That is, the common port 2081 of each third WSS 208 is coupled to one tributary port 2022 of a first WSS 202. Through such arrangement, the configuration of the node may be further optimized as all wavelengths can be dropped from D first fibers 31.

For example, the at least one add-drop component 206 includes M add-drop components 206; 2≤M≤N×S, and M is a positive integer. The D first WSSs 202 coupled to the D third WSSs 208 in the add-drop component 206 are located in D sets of first WSSs 202 respectively, and the first WSSs 202 in each set of first WSSs 202 are coupled to different add-drop components 206. In this way, each add-drop component 206 may drop wavelengths in all degrees.

For example, as shown in FIGS. 6 and 11, the ROADM node may include two add-drop components 206, with one add-drop component 206 coupled to all the upper first WSSs 202 in the D sets of first WSSs 202, and the other add-drop component 206 coupled to all the lower first WSSs 202 in the D sets of first WSSs 202. The common ports 2081 of the D third WSSs 208 in the add-drop component 206 coupled to all the upper first WSSs 202 in the D sets of first WSSs 202 may be coupled to the 31st tributary ports 2022 of all the upper first WSSs 202 in a one-to-one correspondence, and the common ports 2081 of the D third WSSs 208 in the add-drop component 206 coupled to all the lower first WSSs 202 in the D sets of first WSSs 202 may be coupled to the 31st tributary ports 2022 of all the lower first WSSs 202 in a one-to-one correspondence.

For another example, as shown in FIGS. 6 and 11, the ROADM node may include four add-drop components 206, with two add-drop components 206 coupled to all the upper first WSSs 202 in the D sets of first WSSs 202, and the other two add-drop components 206 coupled to all the lower first WSSs 202 in the D sets of first WSSs 202. The common ports 2081 of the D third WSSs 208 in one add-drop component 206 coupled to all the upper first WSSs 202 in the D sets of first WSSs 202 may be coupled to the 31st tributary ports 2022 of all the upper first WSSs 202 in a one-to-one correspondence, and the common ports 2081 of the D third WSSs 208 in the other add-drop component 206 coupled to all the upper first WSSs 202 in the D sets of first WSSs 202 may be coupled to the 32nd tributary ports 2022 of all the upper first WSSs 202 in a one-to-one correspondence. The common ports 2081 of the D third WSSs 208 in one add-drop component 206 coupled to all the lower first WSSs 202 in the D sets of first WSSs 202 may be coupled to the 31st tributary ports 2022 of all the lower first WSSs 202 in a one-to-one correspondence, and the common ports 2081 of the D third WSSs 208 in the other add-drop component 206 coupled to all the lower first WSSs 202 in the D sets of first WSSs 202 may be coupled to the 32nd tributary ports 2022 of all the lower first WSSs 202 in a one-to-one correspondence.

It will be noted that, for the at least one add-drop component 207 coupled to the T tributary ports 2032 of the second WSS 203, the at least one add-drop component 207 includes M′ add-drop components 207; M′ is a positive integer greater than or equal to 2 and less than or equal to N×T (2≤M′≤N×T).

In some embodiments, as shown in FIG. 11, the add-drop card 209 includes an add-drop module 210 with Q input ports and P output ports, and a plurality of fourth WSSs 211 each having one common port and U tributary ports. The common port of each fourth WSS 211 is coupled to one of the Q input ports of the add-drop module 210, and the U tributary ports of the fourth WSS 211 are coupled to U third WSSs of the D′ third WSSs in the add-drop component respectively. U is less than D′ (U<D′), and U, P and Q are all positive integers. The P output ports of the add-drop module 210 are used for dropping or adding wavelengths.

It will be noted that, the Q input ports of the add-drop module 210 may each be coupled to a fourth WSS 211; or, some input ports of the add-drop module 210 may each be coupled to a fourth WSS 211, in which case the remaining input ports of the add-drop module 210 may be idle.

Since the common port of each fourth WSS 211 is coupled to one input port of the add-drop module 210, and each fourth WSS 211 has U tributary ports, this solution is equivalent to that one input port of the add-drop module 210 is scaled to U input ports. As a result, the add-drop card 209 has a maximum of Q×U input ports.

By combining the add-drop module 210 and the plurality of fourth WSSs 211 to obtain the add-drop card 209, it may be possible to make the add-drop component colorless, directionless and contentionless (CDC).

For example, P≥24. For example, P=24, 64, or 128.

For example, D′ is equal to D. As for the connections between the D third WSSs 208 in the add-drop component and the first WSSs 202, reference may be made to the above description.

For example, D′=60, K=32, U=4, and Q=16. In the add-drop card 209, the first to the 15th input ports of the add-drop module 210 are each coupled to a fourth WSS 211 (that is, the add-drop card 209 includes 15 fourth WSSs 211). As shown in FIG. 11, the first tributary ports 2082 of 60 third WSSs 208 are coupled to tributary ports of 15 fourth WSSs 211 in the first add-drop card 209 (in a direction from left to right) in a one-to-one correspondence; the second tributary ports 2082 of 60 third WSSs 208 are coupled to tributary ports of 15 fourth WSSs 211 in the second add-drop card 209 in a one-to-one correspondence; and so forth . . . ; the 32nd tributary ports 2082 of 60 third WSSs 208 are coupled to tributary ports of 15 fourth WSSs 211 in the 32nd add-drop card 209 in a one-to-one correspondence.

In some embodiments, the add-drop component may be a colorless and directionless add-drop component. Based on this, as shown in FIG. 12, the add-drop card 209 includes an add-drop module 212 with Q′ input ports and P output ports. At least part of the Q′ input ports of the add-drop module 212 are coupled to D′ third WSSs 208 in the add-drop component in a one-to-one correspondence. Q′ is greater than or equal to D′ (Q′≥D′), and P and Q′ are both positive integers. The P output ports of the add-drop module 212 are used for dropping or adding wavelengths.

For example, D′ is equal to D. As for the connections between the D third WSSs 208 in the add-drop component and the first WSSs 202, reference may be made to the above description.

For example, D′=60, K=32, and Q′=60. As shown in FIG. 12, the first tributary ports 2082 of 60 third WSSs 208 are coupled to 60 input ports of the add-drop module 212 in the first add-drop card 209 (in a direction from left to right) in a one-to-one correspondence; the second tributary ports 2082 of 60 third WSSs 208 are coupled to 60 input ports of the add-drop module 212 in the second add-drop card 209 in a one-to-one correspondence; and so forth . . . ; the 32nd tributary ports 2082 of 60 third WSSs 208 are coupled to 60 input ports of the add-drop module 212 in the 32nd add-drop card 209 in a one-to-one correspondence.

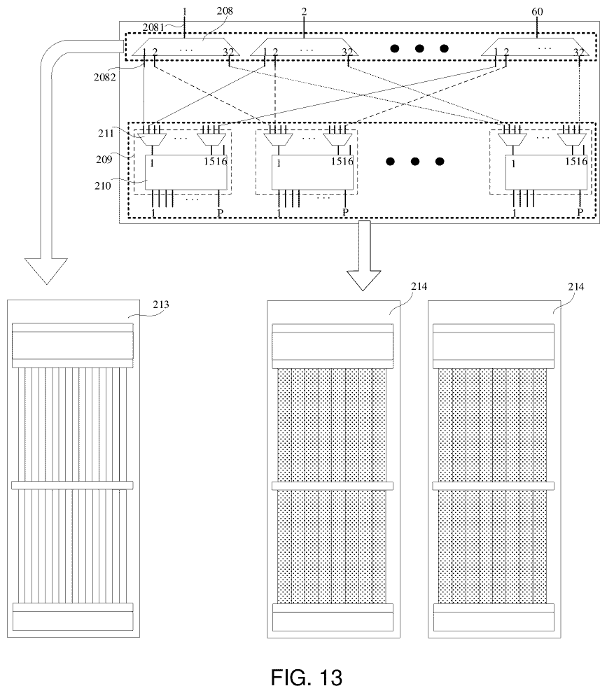

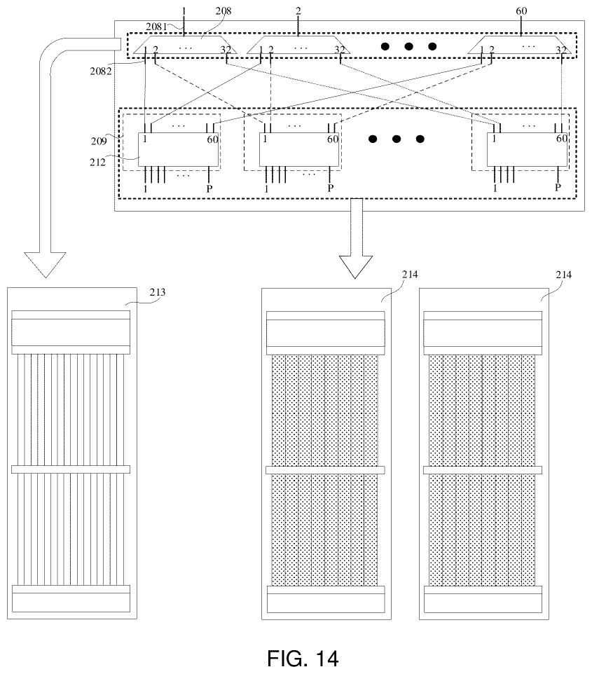

In some embodiments, as shown in FIGS. 13 and 14, the ROADM node 20 includes at least one WSS chassis 213 and at least one add-drop card chassis 214 that are corresponding to each add-drop component. The D′ third WSSs 208 in the add-drop component are installed in the at least one WSS chassis 213, and the K add-drop cards 209 in the add-drop component are installed in the at least one add-drop card chassis 214.

The third WSSs 208 in the WSS chassis 213 and the add-drop cards 209 in the add-drop card chassis 214 may be interconnected through fibers.

By using different chassis to house the third WSSs 208 and the add-drop cards 209 in the add-drop component, the connections between the third WSSs 208 and the add-drop cards 209 may be facilitated.

For example, as shown in FIG. 13, the add-drop component includes 60 third WSSs 208 and 32 add-drop cards 209. The third WSS 208 has one common port 2081 and 32 tributary ports 2082, and the add-drop card 209 includes an add-drop module 210 and 15 fourth WSSs 211. The WSS chassis 213 and the add-drop card chassis 214 are both 32-slot chassis. In the WSS chassis 213, each card occupies two slots, and each card includes the third WSS 208 for drop and the third WSS 208 for add. The 32 add-drop cards 209 are installed in two 32-slot chassis, with each add-drop card 209 occupying two slots. In this way, it may be possible to use conventional chassis to house the components in the add-drop component, and the customers may retain their investments in the equipment they purchased.

For another example, as shown in FIG. 14, the add-drop component includes 60 third WSSs 208 and 32 add-drop cards 209. The third WSS 208 has one common port 2081 and 32 tributary ports 2082, and the add-drop card 209 includes an add-drop module 212 with 60 input ports. The WSS chassis 213 and the add-drop card chassis 214 are both 32-slot chassis. In the WSS chassis 213, each card occupies two slots, and each card includes the third WSS 208 for drop and the third WSS 208 for add. The 32 add-drop cards 209 are installed in two 32-slot chassis, with each add-drop card 209 occupying two slots. In this way, it may be possible to use conventional chassis to house the components in the add-drop component, and the customers may retain their investments in the equipment they purchased.

On the basis of the above two examples, in a case where the ROADM node 20 includes two add-drop components 206, four 32-slot chassis are needed to house 64 add-drop cards 209. In an example where P is equal to 24, in a case where each fiber can carry 80 wavelengths for International Telecommunication Union (ITU) 50 GHz fixed grid, the drop rate=(64×24)/(60×80)=32%.

Similarly, in a case where the ROADM node 20 includes two add-drop components 207, four 32-slot chassis are needed to house 64 add-drop cards 209. In an example where P is equal to 24, in a case where each fiber can carry 80 wavelengths for ITU 50 GHz fixed grid, the add rate=(64×24)/(60×80)=32%.

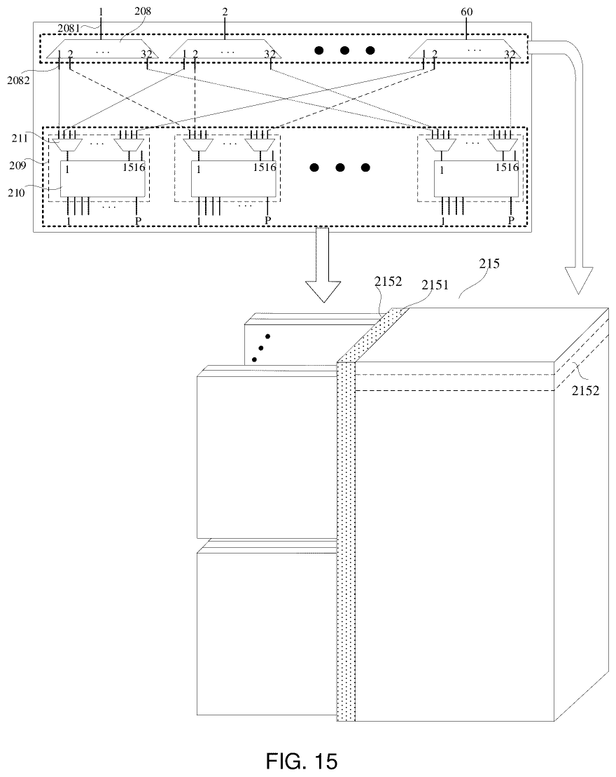

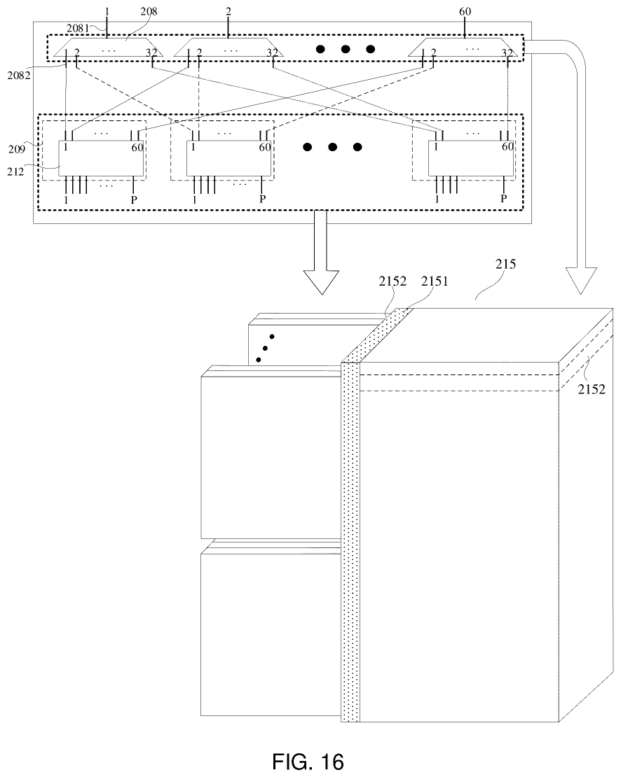

In some embodiments, as shown in FIGS. 15 and 16, the ROADM node 20 includes at least one add-drop card chassis 215 corresponding to each add-drop component, and an add-drop card chassis 215 includes a mid-plane 2151 and slots 2152 located on both sides of the mid-plane 2151. At least part of the D′ third WSSs 208 in the add-drop component are installed in slots 2152 located on one side of the mid-plane 2151, and at least part of the K add-drop cards 209 in the add-drop component are installed in slots 2152 located on the other side of the mid-plane 2151.

The third WSSs 208 and the add-drop cards 209 located on two sides of the mid-plane 2151 are coupled through the mid-plane 2151.

By using a large chassis to house the third WSSs 208 and the add-drop cards 209 in the add-drop component, the number of chassis used may be reduced.

For example, as shown in FIG. 15, the add-drop component includes 60 third WSSs 208 and 32 add-drop cards 209. The third WSS 208 has one common port 2081 and 32 tributary ports 2082, and the add-drop card 209 includes an add-drop module 210 and 15 fourth WSSs 211. The 60 third WSSs 208 are installed in slots 2152 located on the right side of the mid-plane 2151, and the 32 add-drop cards 209 are installed in slots 2152 located on the left side of the mid-plane 2151.

For another example, as shown in FIG. 16, the add-drop component includes 60 third WSSs 208 and 32 add-drop cards 209. The third WSS 208 has one common port 2081 and 32 tributary ports 2082, and the add-drop card 209 includes an add-drop module 212 with 60 input ports. The 60 third WSSs 208 are installed in slots 2152 located on the right side of the mid-plane 2151, and the 32 add-drop cards 209 are installed in slots 2152 located on the left side of the mid-plane 2151.

The foregoing descriptions are merely specific implementations of the present disclosure, but the protection scope of the present disclosure is not limited thereto. Any changes or replacements that a person skilled in the art could readily conceive of within the technical scope of the present disclosure shall be included in the protection scope of the present disclosure. Therefore, the protection scope of the present disclosure shall be subject to the protection scope of the claims.

1. A reconfigurable optical add-drop multiplexer (ROADM) node, comprising:
D splitters, wherein a splitter of the D splitters includes one common port and N tributary ports;
D first sets of first wavelength select switches (WSSs), wherein a set of first WSSs of the first D sets includes N first WSSs, and a first WSS of the N first WSSs includes one common port and K tributary ports;
D second sets of second WSSs, wherein a set of second WSSs of the second D sets includes N second WSSs, and a second WSS of the N second WSSs includes one common port and K tributary ports; and
D combiners, wherein a combiner of the D combiners includes one common port and N tributary ports, wherein:
the common port of the splitter is used for being coupled to a first fiber, and the N tributary ports of the splitter are coupled to common ports of the N first WSSs in the set of first WSSs respectively;
at least part of the K tributary ports of the first WSS are coupled to tributary ports of multiple second WSSs in the D second sets of second WSSs respectively, and at least part of the K tributary ports of the second WSS are coupled to tributary ports of multiple first WSSs in the D first sets of first WSSs respectively;
the common port of the combiner is used for being coupled to a second fiber, and the N tributary ports of the combiner are coupled to common ports of the N second WSSs in the set of second WSSs respectively; and
K is greater than a quotient obtained by dividing D by N (K>D/N), N is greater than or equal to 2 (N≥2), and D, N, K, D/N are positive integers.

2. The ROADM node according to claim 1, wherein:
the set of first WSSs is fully connected to the D second sets of second WSSs.

3. The ROADM node according to claim 2, wherein:
the D second sets of second WSSs include N clusters each including D/N sets of second WSSs; and
D/N tributary ports of each first WSS in the set of first WSSs are coupled to tributary ports of D/N second WSSs in a j-th cluster corresponding to each first WSS in a one-to-one correspondence, any two of the D/N second WSSs in the j-th cluster are located in different sets of second WSSs, and j is a positive integer greater than or equal to 1 and less than or equal to N (1≤j≤N).

4. The ROADM node according to claim 1, wherein:
the set of second WSSs is fully connected to the D first sets of first WSSs.

5. The ROADM node according to claim 4, wherein:
the D first sets of first WSSs include N clusters each including D/N sets of first WSSs; and
D/N tributary ports of each second WSS in the set of second WSSs are coupled to tributary ports of D/N first WSSs in an i-th cluster corresponding to each second WSS in a one-to-one correspondence, any two of the D/N first WSSs in the i-th cluster are located in different sets of first WSSs, and i is a positive integer greater than or equal to 1 and less than or equal to N (1≤i≤N).

6. The ROADM node according to claim 1, wherein:
K is greater than or equal to 16 (K≥16).

7. The ROADM node according to claim 1, wherein:
D=N×(K−S′), wherein K represents a number of tributary ports of the first WSS that are coupled to second WSSs;
S′ represents a number of tributary ports of the first WSS different from tributary ports coupled to the second WSSs, and S′ is a positive integer less than K (S′<K); and
the tributary ports of the first WSS different from the tributary ports coupled to the second WSSs include tributary ports for adding or dropping and other tributary ports except the tributary ports for adding or dropping and the tributary ports coupled to the second WSSs.

8. The ROADM node according to claim 1, wherein:
the splitter is a WSS.

9. The ROADM node according to claim 1, wherein:
the combiner is a WSS.

10. The ROADM node according to claim 1, wherein:
the ROADM node comprises a plurality of line card chassis, and each of the line card chassis includes a plurality of line cards; and
a line card of the plurality of line cards includes the first WSS in at least one of the D first sets of first WSSs or the second WSS in the D second sets of second WSSs.

11. The ROADM node according to claim 10, wherein:
the line card includes one first WSS, one second WSS, and one of the D splitters; or
the line card includes one first WSS, one second WSS, and one of the D combiners; or
the line card includes two first WSSs, two second WSSs, one of the D splitters, and one of the D combiners; or
the line card includes two first WSSs and one of the D splitters; or
the line card includes two second WSSs and one of the D combiners.

12. The ROADM node according to claim 1, further comprising:
at least one add-drop component coupled to S tributary ports of the first WSS, wherein S is less than K (S<K), wherein S is a positive integer, and
wherein, in the first WSS, the S tributary ports of the first WSS coupled to the at least one add-drop component are different from tributary ports coupled to second WSSs.

13. The ROADM node according to claim 1, further comprising:
at least one add-drop component coupled to T tributary ports of the second WSS, wherein T is less than K (T<K), wherein T is a positive integer, and
wherein, in the second WSS, the T tributary ports of the second WSS coupled to the at least one add-drop component are different from tributary ports coupled to first WSSs.

14. The ROADM node according to claim 12, wherein:
an add-drop component in the at least one add-drop component includes D′ third WSSs and K add-drop cards, wherein a third WSS of the D′ third WSSs has one common port and K tributary ports, wherein D′ is a positive integer, and
wherein common ports of the D′ third WSSs are coupled to D′ tributary ports of first WSSs or second WSSs in a one-to-one correspondence, and the K tributary ports of the third WSS are coupled to the K add-drop cards respectively.

15. The ROADM node according to claim 14, wherein:
D′ is equal to D (D′=D); and
the common ports of the D′ third WSSs in the add-drop component are coupled to D tributary ports of D first WSSs or D second WSSs.

16. The ROADM node according to claim 15, wherein:
for the at least one add-drop component coupled to the S tributary ports of the first WSS, the at least one add-drop component includes M add-drop components, M being a positive integer greater than or equal to 2 and less than or equal to N×S (2≤M≤N×S); and the D first WSSs coupled to the D third WSSs in the add-drop component are located in the D first sets of first WSSs respectively, and first WSSs in each set of first WSSs are coupled to different add-drop components;
for at least one add-drop component coupled to the T tributary ports of the second WSS, the at least one add-drop component includes M′ add-drop components, M′ being a positive integer greater than or equal to 2 and less than or equal to N×T (2≤M′≤N×T); and the D second WSSs coupled to the D third WSSs in the add-drop component are located in the D second sets of second WSSs respectively, and second WSSs in each set of second WSSs are coupled to different add-drop components.

17. The ROADM node according to claim 14, wherein:
an add-drop card of the K add-drop cards includes an add-drop module with Q input ports and P output ports, and a plurality of fourth WSSs each including a common port and U tributary ports; the common port of each fourth WSS of the plurality of fourth WSSs is coupled to one of the Q input ports of the add-drop module, and the U tributary ports of each fourth WSS of the plurality of fourth WSSs are coupled to U third WSSs of the D′ third WSSs in the add-drop component respectively; U is less than D′ (U<D′), and U, P and Q are all positive integers; and
the P output ports of the add-drop module are used for dropping or adding wavelengths.

18. The ROADM node according to claim 14, wherein:
an add-drop card of the K add-drop cards includes an add-drop module with Q′ input ports and P output ports, and at least part of the Q′ input ports of the add-drop module are coupled to the D′ third WSSs in the add-drop component in a one-to-one correspondence, wherein Q′ is greater than or equal to D′ (Q′≥D′), and P and Q′ are both positive integers; and
the P output ports of the add-drop module are used for dropping or adding wavelengths.

19. The ROADM node according to claim 14, wherein:
the ROADM node comprises at least one WSS chassis and at least one add-drop card chassis corresponding to each add-drop component;
the D′ third WSSs in the add-drop component are installed in the at least one WSS chassis; and
the K add-drop cards in the add-drop component are installed in the at least one add-drop card chassis.

20. The ROADM node according to claim 14, wherein:
the ROADM node comprises at least one add-drop card chassis corresponding to each add-drop component, and an add-drop card chassis includes a mid-plane and slots located on both sides of the mid-plane;
at least part of the D′ third WSSs in the add-drop component is installed in slots located on a side of the mid-plane; and
at least part of the K add-drop cards in the add-drop component is installed in slots located on another side of the mid-plane.
